(19) United States
(12) Patent Application Publication
(10) Pub. No.: US 2008/0085354 A1
(43) Pub. Date: Apr. 10, 2008

(54) Controlled hydration of hydrocolloids

(76) Inventors: Teresa Marie Paeschke, Minneapolis, MN (US); William R. Aimutis, Blaine, MN (US)

Correspondence Address: FISH & RICHARDSON P.C., PO BOX 1022, MINNEAPOLIS, MN, 55440-1022, US

(21) Appl. No.: 11/544,989

(22) Filed: Oct. 6, 2006

(51) Int. Cl. A23L 1/05

(52) U.S. Cl. 426/573

(57) ABSTRACT

Provided herein are compositions of matter comprising hydrocolloids which are extruded or agglomerated with a carbohydrate and/or a second hydrocolloid, methods for making the same, and methods of using the same to improve the organoleptic properties of dry food products and/or to improve the processing of doughs containing such extruded or agglomerated hydrocolloids.

### TECHNICAL FIELD

Provided herein are compositions of matter comprising hydrocolloids which are extruded or agglomerated with a carbohydrate and/or a second hydrocolloid, methods for making the same, and methods of using the same to improve the organoleptic properties of dry food products and/or to improve the processing of doughs containing such extruded or agglomerated hydrocolloids.

### BACKGROUND

Hydrocolloids, or soluble viscous fibers, are used widely in the food industry to provide body and texture to many food products. In addition to these functions, they provide emulsion stability, control water migration, and prevent ice crystallization in frozen products. To obtain maximum functionality, hydrocolloids must be hydrated, which means that these polymeric materials need to be extended and able to interact with available water.

Hydration of hydrocolloids for use in food products can sometimes be difficult as they must be dispersed in water with a large amount of shear to maximize their functionality and prevent “fish eyes”. “Fish eyes” are semi-hydrated, or swollen, particles of inadequately hydrated hydrocolloids that are undesirable because of their slimy nature and inconsistent texture. Traditionally, dry hydrocolloids can be dispersed in media such as sugars or other dry powders, vegetable oils, or propylene glycol before the addition of sufficient water to fully unravel and extend the polymer. The objective is to separate the hydrocolloid particles so as to allow the particles full access to the water used to hydrate them. Hydration of hydrocolloids can be complicated if there is not enough water available for full hydration or complete unfolding of the polymer, such as in solid foods. The problem can be further complicated as some food formulations do not permit the use of proper dispersion techniques.

Soluble viscous fibers or hydrocolloids may function to lower cholesterol, moderate glucose response, and provide satiety. Unfortunately, they tend to be slimy in nature because of their high viscosity at the levels necessary to produce these desired health effects, and hence consumers avoid ingesting them directly or in food products. Controlling or delaying hydration reduces the slimy nature of these substances, specifically in dry food products such as cookies or snack foods.

### SUMMARY

This disclosure provides compositions and methods to alleviate some of the previously mentioned problems associated with hydrocolloids, while providing maximum functionality of the hydrocolloid to formulate products amenable to consumers.

A composition of the present disclosure can include a hydrocolloid which is agglomerated or extruded with a carbohydrate and/or a second hydrocolloid. Hydrocolloids of the present disclosure can be selected from xanthan gum, guar gum, locust bean gum, gelatin, carrageenan, polygeenan, alginate, pectin, psyllium husk fiber, agar, beta glucan, gellan gum, konjac, carob bean gum, gum Arabic, ghatti gum, tara gum, tragacanth gum, gellan, methyl cellulose, hydroxypropylmethyl cellulose, chitosan, chitin, propylene glycol alginate, and mixtures (e.g., blends) thereof. In some instances, the hydrocolloid can be alginate, pectin, or psyllium husk fiber. When the hydrocolloid is alginate, it can be a high molecular weight alginate.

In some embodiments, the hydrocolloid can be a blend of more than one hydrocolloid, e.g., alginate and pectin, xanthan and alginate, psyllium and pectin, and chitin and xantan. For example, when alginate and pectin are used, the alginate of the blend can be a mixture of both an intermediate weight distribution range form of alginate and a low molecular weight distribution range form of alginate. The ratio of intermediate weight distribution range alginate to low molecular weight distribution range alginate can be from about 0.65:1 to about 2:1. The range can also be from about 0.8:1 to about 0.9:1. In the blend, the ratio of total alginate to total pectin can range from about 8:1 to about 1:8. In some embodiments, the ratio of total alginate to total pectin is 7:1, while in other embodiments the ratio is 6.15:1.

When a hydrocolloid is agglomerated with a carbohydrate, the carbohydrate can be selected from arabinose, ribose, xylose, xylitol, fructose, galactose, glucose, mannose, sorbitol, sucrose, trehalose, isomalt, maltose, maltitol, mannitol, erythritol, ribulose, tagatose, lactitol, cellobiose, polydextrose, inulin, corn dextrin, wheat dextrin, or mixtures thereof. In some cases, the carbohydrate can be polydextrose, inulin, isomalt, trehalose, or sucrose. In other cases, the carbohydrate is polydextrose. Further embodiments can include a carbohydrate in aqueous solution.

When a hydrocolloid is extruded with a carbohydrate, a carbohydrate can be selected from arabinose, ribose, xylose, xylitol, fructose, galactose, glucose, mannose, sorbitol, sucrose, trehalose, isomalt, maltose, maltitol, mannitol, erythritol, ribulose, tagatose, lactitol, cellobiose, or mixtures thereof. In certain embodiments, the carbohydrate is sucrose or trehalose.

The ratio of total hydrocolloid to total carbohydrate can range from about 95:5 to about 10:90 by weight. In other embodiments, the ratio of total hydrocolloid to total carbohydrate can range from about 90:10 to about 60:40. In specific embodiments, the ratio can be 85:15, while in others the ratio can be 75:25. In some cases, the hydrocolloid can be a blend of alginate and pectin and the carbohydrate can be polydextrose.

Compositions may include a component in a glassy matrix. In certain embodiments, at least a portion of the carbohydrate is in a glassy matrix.

In embodiments which include a second hydrocolloid, the second hydrocolloid can be selected from xanthan gum, guar gum, locust bean gum, gelatin, carrageenan, polygeenan, alginate, pectin, psyllium husk fiber, agar, beta glucan, gellan gum, konjac, carob bean gum, gum Arabic, ghatti gum, tara gum, tragacanth gum, gellan, methyl cellulose, hydroxypropylmethyl cellulose, chitosan, chitin, propylene glycol alginate, or mixtures thereof. The second hydrocolloid can be xanthan or pectin. In further embodiments, the hydrocolloid and the second hydrocolloid can be the same, e.g., alginate can be agglomerated with a solution of alginate, or pectin can be agglomerated with a solution of pectin and sucrose.

A composition of the present disclosure can be prepared by cold extruding a hydrocolloid with a carbohydrate or a second hydrocolloid. Optionally, the second hydrocolloid and/or carbohydrate can be in an aqueous solution. In other embodiments, a hydrocolloid of the present disclosure can be prepared by agglomerating a hydrocolloid with a solution of a carbohydrate and/or a solution of a second hydrocolloid.

The present disclosure also provides methods for making compositions comprising extruded or agglomerated hydrocolloids that further include carbohydrates and/or second hydrocolloids. In one embodiment, a hydrocolloid is cold extruded with a carbohydrate and/or second hydrocolloid. The second hydrocolloid and/or carbohydrate can be added to the hydrocolloid as an aqueous solution. In certain embodiments, the hydrocolloid is used in dry form. In further embodiments, cold extrusion can occur at a temperature from about 35° C. to about 80° C. The extruded composition can be used without grinding.

In another embodiment, the hydrocolloid is agglomerated with a solution of carbohydrate and/or a second hydrocolloid. The hydrocolloid can be used in dry form. A solution of carbohydrate and/or second hydrocolloid can be an aqueous solution. In some embodiments, the agglomeration occurs at a temperature from about 25° C. to about 65° C.

A dry food product can be made using the composition of the present disclosure in combination with other food ingredients. The dry food product can be selected from cookies, bars, breads, tortillas, crackers, cereals, pretzels, muffins, confectionary products, and snack foods. In certain embodiments, the addition of the composition does not adversely affect the organoleptic properties of the food product in which it is contained.

Without being bound by theory, it is believed that the extrusion or agglomeration of a hydrocolloid with a carbohydrate and/or a second hydrocolloid can delay the hydration of the hydrocolloid in a dry food product. In addition, the compositions of the present disclosure are believed to alter the organoleptic properties of a dough or a dry food product in which they are contained. An organoleptic property can include a mechanical property (e.g., hardness, cohesiveness, springiness, and orientation), a geometrical property (e.g., particle size and shape and general shape and orientation), or a moisture property (e.g., moistness, moisture release, oiliness, and greasiness). Furthermore, an organoleptic property can include sliminess, tooth pack, and gum pack. In certain embodiments, the alteration of an organoleptic property is as compared to a comparable dough or dry food product containing an unprocessed hydrocolloid.

While not being bound by theory, it is believed that extrusion or agglomeration of a hydrocolloid with a carbohydrate and/or a second hydrocolloid can improve the processability of a dough containing such a composition. In some embodiments, the improvement can include dough lay time. In other embodiments, the improvement can include delayed hydration of the hydrocolloid. Improvements in dough processability can be as compared to a similar dough containing a hydrocolloid not extruded or not agglomerated with a carbohydrate and/or a second hydrocolloid.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows hydration curves for pectin. The pectin was studied as a 3% solution of pectin in a 50% corn syrup/50% water mixture. The pectin used in the solution included unprocessed pectin, pectin extruded alone or pectin coextruded with various carbohydrates.

FIG. 2 shows hydration curves for psyllium. The psyllium was studied as a 3% solution in a 50% corn syrup/50% water mixture. The psyllium used in the solution included unprocessed psyllium, psyllium extruded alone, or psyllium coextruded with various carbohydrates.

FIG. 3 displays hydration curves for an alginate/pectin blend. The alginate/pectin blend was studied as a 3% solution of alginate/pectin blend in a 50% corn syrup/50% water mixture. The alginate/pectin blend used in the solution included unprocessed alginate/pectin blend, alginate/pectin blend extruded alone, or alginate/pectin blend coextruded with various carbohydrates.

FIG. 4 illustrates hydration curves for alginate. The alginate was studied as a 3% solution in a 50% corn syrup/50% water mixture. The alginate used in the solution included unprocessed alginate, alginate extruded alone, or alginate coextruded with various carbohydrates.

FIG. 5 displays a hydration curve for pectin obtained using a chew and swallow method. The pectin studied included unprocessed pectin, as well as pectin extruded alone or coextruded with various carbohydrates.

FIG. 6 illustrates a hydration curve for psyllium obtained using a chew and swallow method. The psyllium studied included unprocessed psyllium, as well as psyllium extruded alone or coextruded with various carbohydrates.

FIG. 7 demonstrates a hydration curve for an alginate/pectin blend obtained using a chew and swallow method. The alginate/pectin blend studied included raw alginate/pectin blend, as well as an alginate/pectin blend extruded alone or coextruded with various carbohydrates.

FIG. 8 shows an adsorption isotherm for unprocessed pectin, extruded pectin, and pectin extruded with various carbohydrates.

FIG. 9 shows an adsorption isotherm for unprocessed alginate/pectin blend, extruded alginate/pectin blend, and alginate/pectin blend extruded with various carbohydrates.

FIG. 10 displays a desportion adsorption isotherm for unprocessed alginate, extruded alginate, and alginate extruded with various carbohydrates.

FIG. 11 displays a desorption isotherm for unprocessed pectin, extruded pectin, and pectin extruded with various carbohydrates.

FIG. 12 illustrates a desorption isotherm for unprocessed alginate/pectin blend, extruded alginate/pectin blend, and alginate/pectin blend extruded with various carbohydrates.

FIG. 13 shows a desorption isotherm for unprocessed alginate, extruded alginate, and alginate extruded with various carbohydrates.

FIG. 14 demonstrates differential scanning calorimeter thermographs comparing glass transitions for an alginate/pectin blend which was extruded alone and with various carbohydrates. The scans are in the order shown in the legend.

FIG. 15 displays differential scanning calorimeter thermographs comparing glass transitions for psyllium which was extruded alone and with various carbohydrates. The scans are in the order shown in the legend.

FIG. 16 illustrates differential scanning calorimeter thermographs comparing glass transitions for pectin which was extruded alone and with various carbohydrates. The scans are in the order shown in the legend.

FIG. 17 shows particle size dissolution over time for unprocessed pectin.

FIG. 18 displays particle size dissolution over time for extruded pectin.

FIG. 19 illustrates particle size dissolution over time for pectin extruded with inulin.

FIG. 20 demonstrates particle size dissolution over time for pectin extruded with polydextrose.

FIG. 21 shows particle size dissolution over time for pectin extruded with isomalt.

### DETAILED DESCRIPTION

Materials and methods for the preparation of hydrocolloids extruded or agglomerated with a carbohydrate and/or a second hydrocolloid for use in dry food products are provided herein. Extruded or agglomerated hydrocolloid compositions of this disclosure may include one or more hydrocolloids and contain a second hydrocolloid and/or carbohydrate. In one embodiment, the hydrocolloids and carbohydrates are coextruded to produce the extruded hydrocolloid compositions. In another embodiment, the hydrocolloid, carbohydrates, and/or second hydrocolloid are combined through agglomeration. Processing hydrocolloids using these techniques can delay hydration and improve the organoleptic properties of the dry food products in which they are contained. Furthermore, the extruded or agglomerated hydrocolloids of the present disclosure may improve the processability of the doughs containing these hydrocolloids.

### Extruded or Agglomerated Hydrocolloid Compositions

An extruded or agglomerated hydrocolloid composition can include a hydrocolloid extruded or agglomerated with a carbohydrate and/or a second hydrocolloid.

In some embodiments, the amount of a hydrocolloid by weight of an extruded or agglomerated hydrocolloid composition can range from about 10% to about 99.95% (e.g., 10%, 15%, 20%, 25%, 30%, 35%, 40%, 45%, 50%, 55%, 60%, 65%, 70%, 75%, 80%, 85%, 90%, 95%, or 99%) of the total weight of the extruded or agglomerated composition. In other embodiments, the amount of a hydrocolloid by weight of an extruded or agglomerated hydrocolloid composition can range from about 50% to about 100%. In still further embodiments, the amount of a hydrocolloid by weight of an extruded or agglomerated hydrocolloid composition can be 75%.

As used herein, a recitation of a range of values is merely intended to serve as a shorthand method of referring individually to each separate value falling within the range, and each separate value is incorporated into the specification as if it were individually recited herein.

Hydrocolloids or soluble fibers which may be included in the present disclosure include, but are not limited to, any variety of plant-derived, microbially-derived, crustacean-derived, or animal-derived fiber. Unless indicated otherwise, the term hydrocolloid refers to all forms (e.g., protonated or salt forms, such as sodium, potassium, calcium, magnesium, and ammonium salt forms and forms having varying average molecular weight distribution ranges) of the fiber type. For further information, see U.S. patent application Ser. No. 11/246/646, entitled “Fiber Satiety Compositions”, Attorney Docket number 10790-056001, and U.S. patent application Ser. No. 11/246/938, entitled “Fiber Satiety Compositions”, Attorney Docket number 10790-056002, both filed on Oct. 7, 2005, and which are incorporated in their entirety by reference herein. See also U.S. patent application Ser. No. ______, entitled “Compositions and Methods for Reducing Food Intake and Controlling Weight,” Attorney Docket No. MSP5038USCIP, filed Oct. 6, 2006, which is incorporated in its entirety by reference herein.

Examples of hydrocolloids include xanthan gum, guar gum, locust bean gum, gelatin, carrageenan, polygeenan, alginate (e.g., sodium alginate, potassium alginate, ammonium alginate, and alginic acid), pectin (e.g., high methoxy pectin, low methoxy pectin, and amidated pectin), psyllium husk fiber, agar, beta glucan, gellan gum, konjac, carob bean gum, gum Arabic, ghatti gum, karaya gum, tara gum, tragacanth gum, gellan, methyl cellulose, hydroxypropylmethyl cellulose, chitosan, chitin, propylene glycol alginate, and mixtures (e.g., blends) thereof.

In some embodiments, the hydrocolloid is alginate, pectin, psyllium husk fiber, or a blend of alginate and pectin.

In certain cases, two or more hydrocolloid types are included, such as blends of alginate and pectin (e.g., sodium alginate and pectin), alginate and gellan, pectin and gellan, alginate and psyllium husk fiber, or pectin and psyllium husk fiber. In other cases, only one type of hydrocolloid is used, such as only alginate, only pectin, only carrageenan, or only psyllium husk fiber. When a certain hydrocolloid type is used (e.g., alginate), in certain cases, more than one form of that type can be used, e.g., an intermediate molecular weight alginate and a low molecular weight alginate can be used, as described more fully below.

An alginate can be a high guluronic acid alginate. For example, in certain cases, an alginate can exhibit a higher than 1:1 ratio of guluronic to mannuronic acids (g:m ratio), such as in the range from about 1.2:1 to about 3:1, e.g., about 1.3:1, about 1.4:1, about 1.5:1, about 1.6:1, about 1.7:1, about 1.8:1, about 2:1, about 2.2:1, about 2:5:1, about 2:8:1, and about 2:9:1. Examples of high guluronic alginates (e.g., having a higher than 1:1 g:m ratios) include Manugel LBA, Manugel GHB, and Manugel DPB, which each have a g:m ratio of about 1.5:1. Manugel DMB and Protanal LF5/60 can also be used.

In other cases, an alginate can exhibit a ratio of guluronic to mannuronic acids of less than 1:1, e.g., 0.8:1 to about 0.4:1, such as about 0.5:1, about 0.6:1, or about 0.7:1. Keltone LV and Keltone HV are examples of high-mannuronic acids (e.g., having a g:m ratio of less than 1:1). Methods for measuring the ratio of guluronic acids to mannuronic acids are known by those having ordinary skill in the art.

An alginate can exhibit any number average molecular weight distribution ranges, such as a high molecular weight distribution range (about 7×10⁵ to about 1×10⁶ molar mass; examples include Manugel DPB, Keltone HV, and TIC 900 Alginate); an intermediate molecular weight distribution range (about 2×10⁴ to about 6×10⁵ molar mass; examples include Manugel GHB); or a low molecular weight distribution range (2×10³ to about 1×10⁵ molar mass; examples include Manugel LBA and Manugel LBB). Number average molecular weights can be determined by those having ordinary skill in the art, e.g., using size exclusion chromatography (SEC) combined with refractive index (RI) and multi-angle laser light scattering (MALLS).

In certain embodiments, a low molecular weight alginate can be used (e.g., Manugel LBA), while in other cases a mixture of low molecular weight (e.g., Manugel LBA) and high molecular weight (e.g., Manugel DPB, Keltone HV) alginates can be used. In other cases, a mixture of low molecular weight (e.g., Manugel LBA) and intermediate molecular weight (e.g., Manugel GHB) alginates can be used. In yet other cases, one or more high molecular weight alginates can be used (e.g., Keltone HV, Manugel DPB).

A pectin can be a high-methoxy pectin (e.g., having greater than 50% esterified carboxylates), such as ISP HM70LV and CP Kelco USPL200. A pectin can exhibit any number average molecular weight ranges, including a low molecular weight distribution range (about 3×10³ to about 6×10⁵ molar mass, e.g., CP Kelco USPL200), an intermediate molecular weight distribution range (about 2×10⁴ to about 7×10⁵, e.g., ISP HM70LV), or high molecular weight distribution range (about 1×10⁴ to about 1×10⁶, e.g., TIC HM Pectin). In certain cases, a high-methoxy pectin can be obtained from pulp, e.g., as a by-product of orange juice or other fruit processing.

A gellan anionic soluble fiber can also be used. Gellan fibers form strong gels at lower concentrations than alginates and/or pectins, and can cross-link with mono- and divalent cations. For example, gellan can form gels with sodium, potassium, magnesium, and calcium. Gellans for use in the invention include Kelcogel, available commercially from CP Kelco.

A psyllium husk fiber may also be used. When psyllium husk fiber comes in contact with water, it swells and forms a gelatinous mass. In fact, this fiber can swell to 35 to 50 times its original size. Psyllium has had a long tradition of use as a bulking and lubricating agent for the digestive system. In addition, it has found application in alleviating symptoms associate with colon cancer, diabetes, and coronary heart disease.

Hydrocolloids such as alginate, pectin, carrageenan, psyllium husk fiber, and gellan are commercially available, e.g., from ISP (Wayne, N.J.), TIC Gums (Belcamp, Md.), and CP Kelco (Atlanta, Ga.).

Hydrocolloid blends can also be used in the preparation of an extruded or agglomerated hydrocolloid composition. A useful hydrocolloid blend can include alginate and pectin. Alginate in a blend can be a mixture of two or more alginate forms, e.g., an intermediate and low molecular weight alginate; a high molecular weight and low molecular weight alginate; two intermediate molecular weight alginates; or two low molecular weight alginates.

A ratio of total alginate to total pectin in a blend can be from about 8:1 to about 5:1, or any value therebetween, such as about 7:1, about 6.5:1, about 6.2:1, or about 6.15:1. A ratio of an intermediate molecular weight alginate to a low molecular weight alginate can range from about 0.65:1 to about 2:1, or any value therebetween (e.g., about 0.75:1; about 1:1; about 1.25:1; about 1.5:1; or about 1.75:1). In certain cases, a ratio of an intermediate molecular weight alginate to a low molecular weight alginate is about 0.8:1 to about 0.9:1.

Carbohydrates which may find use in an extruded or agglomerated hydrocolloid composition may be, without limitation, any sugar, sugar alcohol, or oligosaccharide that is capable of forming a carbohydrate glass. For example, arabinose, ribose, xylose, xylitol, fructose, galactose, glucose, mannose, sorbitol, sucrose, trehalose, isomalt, lactose, maltose, maltitol, mannitol, erythritol, ribulose, tagatose, lactitol, cellobiose, polydextrose, inulin, corn dextrin, wheat dextrin, and mixtures thereof can be used in an agglomerated hydrocolloid composition.

In other embodiments, when an extruded hydrocolloid composition is desired, small carbohydrates may be used, such as arabinose, ribose, xylose, xylitol, fructose, galactose, glucose, mannose, sorbitol, sucrose, trehalose, isomalt, lactose, maltose, maltitol, mannitol, erythritol, ribulose, tagatose, lactitol, cellobiose, and mixtures thereof.

In some embodiments, a single carbohydrate may be used (e.g., polydextrose, sucrose, trehalose, inulin, or isomalt), while in others, a blend of more than one carbohydrate may be incorporated into an extruded or agglomerated hydrocolloid (e.g., arabinose and trehalose, xylose and polydextrose, ribose and inulin, or xylitol, ribose, and polydextrose). In certain embodiments, the carbohydrate may be used in an aqueous solution.

In certain embodiments, the amount of carbohydrate by weight to total extruded or agglomerated hydrocolloid composition can range from about 0% to about 90% (e.g., 0%, 5%, 10%, 15%, 20%, 25%, 30%, 35%, 40%, 45%, 50%, 55%, 60%, 65%, 70%, 75%, 80%, 85%, and 90%). In other embodiments, the amount of carbohydrate by weight to total extruded or agglomerated hydrocolloid composition can range from about 0 to about 40%. While in still further embodiments, the amount of carbohydrate by weight to extruded or agglomerated hydrocolloid composition may be 25%.

A hydrocolloid (e.g., a hydrocolloid blend) and a carbohydrate can be in a ratio of total hydrocolloid to total carbohydrate of about 95:5 to about 10:90 (e.g., 95:5, 90:10, 85:15, 75:25, 60:40, 50:50, 40:60, 25:75, 15:85, and 10:90). For example, a hydrocolloid blend of alginate and pectin may be used with a carbohydrate (e.g., polydextrose) in a ratio of total hydrocolloid to total carbohydrate of 75:25.

Suitable second hydrocolloids include, but are not limited to, any variety of plant-derived, microbially-derived, crustacean-derived, or animal-derived fiber. Examples include xanthan gum, guar gum, locust bean gum, gelatin, carrageenan, polygeenan, alginate (e.g., sodium alginate, potassium alginate, ammonium alginate, and alginic acid), pectin (e.g., high methoxy pectin, low methoxy pectin, and amidated pectin), psyllium husk fiber, agar, beta glucan, gellan gum, konjac, carob bean gum, gum Arabic, ghatti gum, karaya gum, tara gum, tragacanth gum, gellan, methyl cellulose, hydroxypropylmethyl cellulose, chitosan, chitin, propylene glycol alginate, or mixtures thereof. In certain embodiments, the second hydrocolloid can be xanthan or pectin. In other embodiments, the hydrocolloid and the second hydrocolloid can be the same, e.g., alginate can be agglomerated with a solution of alginate, pectin can be extruded with a solution of pectin and sucrose, and psyllium can be agglomerated with a solution of psyllium and polydextrose.

In some embodiments, the amount of second hydrocolloid used in an ingestible composition can range from about 0% to about 5% (e.g., 0%, 0.05%, 0.1%, 0.25%, 0.5%, 0.75%, 1%, 1.5%, 2.5%, 3%, 4%, and 5%) by weight of the extruded or agglomerated hydrocolloid composition. In certain embodiments, the second hydrocolloid is used in solution (e.g., water, vegetable oil, or propylene glycol solution).

When used together in an extruded or agglomerated hydrocolloid, the ratio of hydrocolloid (e.g., a hydrocolloid blend) to second hydrocolloid can be in a ratio of about 99.95:0.05 to about 95:5 (e.g., 99.9:0.1, 99.5:0.5, 99:1, 98.5:1.5, 98:2, 97:3, 96.5:3.5, and 96:4). For example, a hydrocolloid blend of alginate and pectin may be extruded or agglomerated with a second hydrocolloid (e.g., xanthan) in a ratio of about 97:3.

In other embodiments, both a second hydrocolloid and a carbohydrate are used. When used in combination, the percent hydrocolloid can range from 35% to 89% (e.g., 35%, 37%, 40%, 50%, 60%, 75%, 80%, 85%, or 89%), the second hydrocolloid can range from 1% to 5% (e.g., 1.5%, 2%, 4%, 4.5%, or 5%), and the carbohydrate can range from 10% to 60% (11%, 15%, 22%, 25%, 30%, 37%, 40%, 50%, or 60%), with the total of the three components adding up to 100%. Any combination of hydrocolloid, second hydrocolloid, and carbohydrate may be selected from those listed above. For example, pectin can be used as the hydrocolloid, xanthan as the second hydrocolloid, and sucrose as the carbohydrate, alginate can be used as the hydrocolloid, pectin as the second hydrocolloid, and polydextrose as the carbohydrate, and alginate/pectin blend can be used as the hydrocolloid, xanthan as the second hydrocolloid, and trehalose as the carbohydrate.

### Methods of Making Extruded or Agglomerated Hydrocolloid Compositions

In one embodiment, the preparation of an extruded hydrocolloid composition may include extrusion of a hydrocolloid, or a blend of hydrocolloids with a carbohydrate and/or a second hydrocolloid. The components can be combined and then coextruded.

Extrusion for the manufacture of foods and food ingredients has long been used in the food industry. It has applications with a wide range of ingredients, for example, grains, fibers, and refined starches and proteins have been combined using extrusion to produce foods including cereals, pet foods, meat analogs, flavor carriers, and snacks.

The basic process involves blending of the dry ingredients (e.g., a hydrocolloid optionally with a second hydrocolloid and/or carbohydrate) in the desired proportions and conveying the dry ingredients to the extruder. The dry ingredients may be directly conveyed or passed through a pre-conditioner where moisture may be added and the mix may be warmed up before entering the extruder. The material is then introduced into the hopper of the extruder and passed through different zones in the extruder that mix, shear, and compress the material. Water or liquid ingredients (e.g., an aqueous solution of second hydrocolloid and/or carbohydrate) may be directly introduced into the extruder barrel (optionally at different points) to mix with the dry ingredients to form a dough. Some extruders are jacketed so that the temperature can be raised or lowered by passing a thermal liquid through the jacket, though many extruders are not jacketed. The screw(s) conveying the material compress the material into a dough. The rubbery dough is pressed through a die to shape the dough and the dough is cut with some form of rotary knife. Typically, water is removed by passing the extruded pieces through a belt oven or fluid bed dryer.

With the wide variety of materials, equipment and desired product characteristics involved in extrusion, the present disclosure encompasses any extrusion method that produces materials that meet the requirements as described herein. For example, both single-screw and twin-screw extruders may be used to produce the extruded hydrocolloid composition. In some embodiments, the extrusion process may be considered to be cold extrusion. Cold extrusion can occur at temperatures from about 30° C. to about 100° C. (e.g., about 30° C. to about 50° C., about 40° C. to about 60° C., about 35° C. to about 65° C., about 50° C. to about 75° C., about 45° C. to about 70° C., about 50° C. to about 75° C., about 60° C. to about 80° C., about 85° C. to about 100° C.). In certain embodiments, the extrusion occurs at a temperature of about 35° C. to about 80° C. Those skilled in the art will know to change the water (or solution of second hydrocolloid and/or carbohydrate) added to the extruder, the feed rate of the dry materials, and optionally the jacket temperature to insure that the resulting product has the desired characteristics of color, density, shape, homogeneity and particle size.

The final shape of the extruded product is determined by the die through which a material (e.g., a mixture of hydrocolloids and carbohydrates) is drawn through. When a small enough die is used, the additional step of grinding the extruded product can be eliminated, therefore allowing immediate use of the extruded product in further processing applications without additional manipulation. In other embodiments, the extruded product may be ground prior to use.

In certain embodiments, a hydrocolloid blend (e.g., an alginate/pectin blend) is added to the hopper of an extruder. In other embodiments, a carbohydrate is mixed with the hydrocolloid in a ribbon blender before being added to the hopper of an extruder. To the hydrocolloid, a solution may be added through an injector (e.g., water, or a solution of second hydrocolloid and/or carbohydrate). The mixture is then extruded through the extruder to produce the extruded hydrocolloid composition. This extruded hydrocolloid composition may then be used in further applications, such as in the production of a dry food product.

As an example, a dry blend of a hydrocolloid, e.g., alginate and pectin, is transferred to a feeder (e.g., a K-Tron loss-in-weight feeder), and into the hopper of an extruder, (e.g., a Buhler Twin Screw Extruder configured with at least one heating unit (e.g., two Mokon barrel-heating units)). Water can be optionally added to the dry blend, using an injection system. A second liquid (e.g., an aqueous solution of a second hydrocolloid and/or a carbohydrate) may be introduced at variable rates using another injector. The carbohydrate can be fully or partially in solution, while the second hydrocolloid should be fully dissolved. The dry hydrocolloid does not need to be fully saturated with the solution of carbohydrate and/or second hydrocolloid. A second loss-in-weight feeder may be used to introduce other dry ingredients. The blend is then mixed and conveyed in the extruder with temperatures ranging from 35° C. to 80° C. The product stream is then forced through a die, cut, and conveyed by vacuum or mechanical conveying to a fluid bed drier (e.g., Buhler fluid bed drier) and dried to the desired moisture content. The fluid bed drier can dry about 50 to about 100 kg/hour at temperatures from about 80° C. to about 100° C. The product can be ground for further use. Alternatively, the product can be extruded through a die with small diameter (1 mm) and cut to the desired size without further grinding.

In accordance with the present disclosure, any conventional extrusion apparatus and method can be used. In the embodiments described herein, a moist or wet extrusion process is preferred. Such moist extrusion includes adding water (or a solution of a second hydrocolloid and/or carbohydrate) during the extrusion process, or adding water (or a solution of a second hydrocolloid and/or carbohydrate) to the dry ingredients prior to extrusion, as described herein.

While not being bound by theory, it is believed that the extrusion process alters the structure of hydrocolloids, and these structural changes permit the inclusion of the extruded hydrocolloids in food products, without deleterious organoleptic effects. For example, carbohydrates can form a glassy matrix when extruded with hydrocolloids. The glassy matrix may be responsible for the slower penetration of moisture into the hydrocolloid, and therefore may prevent the formation of slimy regions or “fish eyes” in the product in which it is contained.

In another embodiment of the present disclosure, a hydrocolloid and a carbohydrate and/or second hydrocolloid may be processed by agglomeration. In some instances, the hydrocolloid and a carbohydrate and/or second hydrocolloid may be processed by spray agglomeration, although other granulation or agglomeration techniques may be utilized. Fluidized bed agglomeration, more commonly referred to as spray agglomeration, is faster than conventional two step granulations and can be accomplished within a single processing unit. Fluidized bed spray agglomeration facilitates ultimate distribution of particles on or in an agglomeration bed. The liquid (e.g., a carbohydrate and/or second hydrocolloid in solution) used to agglomerate a fluidized bed is introduced as a finely dispersed air atomized droplet or fog.

During the spray agglomeration process, the bed of the agglomerator can contain the material (e.g., a hydrocolloid) to be agglomerated, and the material is kept in motion by filtered, heated, high velocity air. While the bed is in motion, an air-atomized agglomeration solution or suspension (e.g., an aqueous solution of second hydrocolloid and/or carbohydrate), is intermittently sprayed onto the dynamic fluidized bed. Following each spray cycle the bed containment filters are purged in order to return any unagglomerated material to the bed. The bed is again fluidized and the spray-filter purge cycles are continued until the entire dynamic fluidized bed has been uniformly agglomerated and the spray agglomeration solution or suspension has been exhausted. In some embodiments, pectin is placed into the bowl or bed of an agglomerator. A solution of polydextrose is sprayed onto the dry hydrocolloid while it is being suspended, and the mixture is agglomerated at a temperature ranging from about 25° C. to about 65° C. to produce the desired agglomerated hydrocolloid composition. Optionally, the particles may be sieved to less than 20 mesh (e.g., 20 mesh, 30 mesh, 40 mesh, 50 mesh, or 60 mesh).

While not being bound by theory, it is believed that while in the agglomerator bed, the hydrocolloid particles are moving about, colliding with each other. During spraying, the surfaces of the hydrocolloid particles may become coated with the solution (e.g., a solution of carbohydrate and/or second hydrocolloid), making the particles wet and tacky. The wet and tacky particles may then stick together after a collision. Spraying and drying intervals may be continued until agglomerated particles are formed.

Processing hydrocolloids as described herein may reduce the sliminess of hydrocolloids. Controlling or delaying hydration can also provide benefits in food processing by providing an even and uniform distribution of the hydrocolloid preventing “fish eyes”. In dry consumer goods, such as cookies or snack products, controlled or delayed hydration of hydrocolloids can alleviate the slimy nature of these ingredients in food products by delaying hydration until the product is swallowed. The hydrocolloid can then hydrate during digestion to provide the benefits of soluble fiber.

As described, a hydrocolloid may be processed with a carbohydrate to control or delay hydration. In some embodiments, the carbohydrate can form a glassy state, which is believed to delay hydration. A substance in the glassy state is a stable amorphous solid without crystalline structure. These substances are actually supercooled liquids, but appear as solids. The glass transition temperature (Tg) is the temperature at which the substance transforms from a glassy to a rubbery elastic state (for food products, this means that water is able to diffuse through the matrix of a food product). Thermodynamically, this is characterized as a second order phase transition that can be measured by monitoring a change in specific volume, a viscosity increase on the order of 10¹⁴, or a change in heat capacity. Practically, it means that a food product can readily adsorb water and become unstable with regard to maintaining a flowable powdered form, microbial stability, or in product stability. For example, carbohydrates or proteins that experience temperatures above their glass transition temperature clump and become solid masses, making them difficult to use in further food processing. The glass transition temperature of carbohydrates is a function of the molecular structure and/or molecular weight of the carbohydrate and depends heavily on the water content of the food product from which it is made. While not being bound by theory, it is believed that the glassy state hydrates more slowly, alleviating processing problems and organoleptic aversions to consumption until the glass transition temperature is reached. At this temperature, the composite of hydrocolloid and carbohydrate glass becomes rubbery and readily dissolves.

Processing hydrocolloids or soluble fibers with carbohydrates that exhibit glassy structures at room temperature provides a way to inhibit unwanted hydration for both organoleptic and processing concerns.

In the case of carbohydrates, extrusion or agglomeration results in the dispersion of the hydrocolloid or soluble fiber in a glassy matrix. When the dried mixture is exposed to a large amount of water, the carbohydrate softens as the glass transition temperature drops, providing a slow dissolution that will hydrate the hydrocolloid, and prevent “fish eyes”, lumping, or clumping. In a dry food system, such as a low moisture cookie, cracker, or confection, the glassy matrix will slow diffusion of water to the hydrocolloid, preventing premature hydration, which aids in processing, reduces organoleptic sliminess when chewed or ingested, and may increase shelf-life.

In the case of extruding or agglomerating a hydrocolloid with a second hydrocolloid in solution, the extended polymer coats the wetted hydrocolloid/soluble fiber dry blend to delay hydration. Agglomeration or extrusion with a second hydrocolloid in solution, rather than dry addition, creates a film type structure encapsulating (with agglomeration) or in a matrix form (extrusion) that is denser and more difficult to hydrate than standard alcohol precipitated hydrocolloids. Hydrocolloids are often manufactured by alcohol precipitation and a porous, fibrous, sponge like structure results. The porous nature of the alcohol precipitated hydrocolloid is more favorable to hydration than a fully extended polymer that results from using the hydrocolloid in a solution state. This latter treatment allows the hydrocolloid to form a film-like structure when dried, therefore making hydration of this form of hydrocolloid more difficult.

### Method of Making a Dry Food Product

The extruded or agglomerated hydrocolloid compositions of the present disclosure may find utility in many dry food products. Methods for making these dry food products, such as, without limitation, bars, breads, muffins, cookies, brownies, cereals, crackers, chips, tortillas, snack foods, bagels, confectionary products (e.g., chews, hard candy, nougat, and chocolate) and pretzels, are provided herein. As used herein, the dry food products described may contain a hydrocolloid extruded or agglomerated with a carbohydrate and/or second hydrocolloid. This extruded or agglomerated hydrocolloid composition may be prepared by any of the methods described herein, prior to its incorporation into the final food product. The addition of the hydrocolloid compositions of the present disclosure may improve the organoleptic properties of the food product relative to a similar food product made with unprocessed hydrocolloids.

Food products of the present disclosure can provide from about 0.5 g to about 10 g total soluble fiber per serving, e.g., about 0.5 g to about 5 g, about 1 g to about 6 g, about 3 g to about 7 g, about 5 g to about 9 g, or about 4 g to about 6 g. For example, in some cases, about 1 g, about 2 g, about 3 g, about 4 g, about 5 g, about 6 g, about 7 g, about 8 g, or about 9 g of soluble fiber per serving can be provided. As used herein, unless indicated otherwise, a serving is considered to be the “reference amount customarily consumed” or RACC.

A dry food product can include an extruded or agglomerated hydrocolloid composition at a total weight percent of the food product of about 1% to about 50%. For example, a food product can include one or more hydrocolloids extruded or agglomerated with a carbohydrate and/or a second hydrocolloid from about 1% to about 10% by weight; or about 5% to about 15% by weight; or about 10% to about 20% by weight; or about 20% to about 30% by weight; or about 30% to about 40% by weight; or about 40% to about 50% by weight.

### Organoleptic Properties

Dry food products containing the extruded or agglomerated compositions of the present disclosure function to improve the organoleptic or rheological properties of the dry food products relative to similar products which contain hydrocolloids not processed by the methods provided herein. As used herein, the term organoleptic refers to the sensory properties of a dry food product (e.g., a cookie). These sensory properties may include, without limitation, taste, color, odor, and feel. Organoleptic testing involves inspection through visual examination, feeling, tasting, and smelling of hydrocolloid compositions or food products. Organoleptic properties may be tested by a trained panel of food tasters or may be determined using specialized instrumentation, such as a TA.XT2 Texture Analyzer, available from Texture Technologies. Determinations of improvements to organoleptic properties are often based on comparisons made to a control product.

While not being limited by theory, some examples of general categories of organoleptic properties include mechanical, geometrical, and moisture properties. Mechanical properties of a food product can include hardness (e.g., soft, firm, or hard), cohesiveness (e.g., fracturability, chewiness, sliminess, or gumminess), viscosity, springiness (e.g., elasticity or rubberiness), and adhesiveness (e.g., stickiness, tackiness, or gooiness). Geometrical properties can fall into two general categories: 1) characteristics relating to particle size and shape (e.g., powdery, chalky, grainy, glassy, gritty, lumpy, or beady) and 2) characteristics relating to shape and orientation (e.g., fibrous, pulpy, cellular, aerated, or crystalline). Finally, moisture properties can include moistness, moisture release (i.e., juiciness), oiliness, or greasiness. In addition, the organoleptic properties of sliminess, tooth pack, and gum pack are particularly important in foods containing hydrocolloids. These and other properties known to those of skill in the art can be used in the evaluation of a food product. Organoleptic properties may play a significant role in consumer desire to consume hydrocolloid containing food products.

As has been discussed previously, unprocessed hydrocolloids or soluble fibers are generally considered to have a slimy texture when used within dry food products. The present disclosure provides methods in which to process hydrocolloids in a manner which may avoid this undesirable organoleptic property. The processing of hydrocolloids in the presence of carbohydrates and/or a second hydrocolloid (e.g., coextruded with the hydrocolloid or coagglomerated with the hydrocolloid) may help to reduce sliminess of the ingestible composition in the mouth and to aid in hydration and gellation of the fibers in the stomach and/or small intestine. Without being bound by theory, it is believed that treatment of the hydrocolloid(s) with such ingredients prevents early hydration of the fibers in the mouth, which can lead to sliminess and unpalatability. In addition, treatment may delay hydration and subsequent gellation of the hydrocolloid until the ingestible composition or food product reaches the stomach and/or small intestine, providing for the induction of satiety and/or satiation. This treatment may also further decrease the appearance of “fish eyes” within hydrocolloid containing food products.

### Improvements to Dough Processability

When a dough for a dry food product is prepared on a commercial scale, the physical properties of the dough are crucial for acceptable performance in later stages of food processing, particularly during rolling or extrusion of the dough, and cutting the dough strand or sheet thereby produced into portions for subsequent baking. Dough that is too sticky or viscous will bind to equipment, slowing processing and preventing the formation of uniform portions for baking. Dough that crumbles readily or lacks sufficient tackiness will resist formation into an acceptable strand or sheet, and portions produced for subsequent baking will form crumbs or not maintain their integrity. The incorporation of hydrocolloids in a dough can complicate the production of a dough with acceptable lay times.

Dough lay time is a measure, in minutes, of the amount of time after its formation that dough will maintain acceptable properties for commercial processing. Improvements to the dough lay performance of compositions that include hydrocolloids have great commercial value. In particular, and without being bound by theory, it is believed that hydrocolloids tends to hydrate slowly after the dough is formed, and this hydration is accompanied by a decrease in the amount of unbound water in the dough, resulting in a dry dough which crumbles or lacks integrity. Attempts to compensate for this behavior by increasing the initial water content of the dough may result in the dough being initially too sticky, rendering it unacceptable for commercial processes.

To evaluate the dough lay times of a dough comprising a hydrocolloid, a subjective dough lay test can include a subjective cohesiveness rating, e.g., as evaluated by a trained sensory panel. One example is based on a scale of 1 to 5 (1 is very poor performance; 5 is good performance). Generally, a dough lay score of 4 can be preferred for acceptable processing on a plant scale, and a score of 4.5 is highly preferred.

The dough lay test can be performed by weighing a portion of dough and compressing the dough in the hand by one trained or skilled in the art, or by a sensory panel trained in evaluating doughs. The cohesiveness of the dough is evaluated on the above 1-5 scale, with performance of 1 represented by material that is dry, crumbly, and not cohesive. In particular, it does not form a ball when squeezed, or the ball falls apart easily. A performance of 5 is represented by moist dough that compresses when squeezed. A ball formed in the hand remains tightly compressed, and the hand feels moist or sticky thereafter. After a batch of dough is produced, the dough test is performed immediately (0 minute time point), as well as 15, 30, and 45 minutes after production. The amount of time that dough maintains acceptable performance (that is, a score of 4 or greater) is a measure of how much time is available for commercial processing of the dough after it is produced.

Hydrocolloids extruded or agglomerated with a carbohydrate and/or second hydrocolloid may be able to improve dough lay times by delaying hydration of the hydrocolloid. This delayed hydration may prevent the removal of moisture from the surrounding dough, making longer processing times possible.

A number of embodiments of the invention have been described. Nevertheless, it will be understood that various modifications may be made without departing from the spirit and scope of the invention. Accordingly, other embodiments are within the scope of the following claims.

### EXAMPLES

### Example 1

### Extrusion of Hydrocolloids

Hydrocolloid(s) and carbohydrate(s) were dry blended in a small ribbon blender. The resulting dry blend was transferred to a K-Tron loss-in-weight feeder, into the hopper of a Buhler Twin Screw Extruder. Water was injected into the barrel in the approximate ratio of 2 parts water to 2.5-3 parts of dry blend. The dough was mixed and conveyed with the twin screws at an approximate speed of 80-150 rpm at a temperature of 30 to 60° C. With some samples, a second hydrocolloid in solution was injected through a second port. The mixture was then forced through a small die at the end of the screw conveyor and through a cutter, which cut the dough into small pieces. The wet pieces were transferred either manually or pneumatically conveyed to a Buhler fluidized bed drier at 100° C. for approximately 5-20 minutes, depending on the size of the pieces.

Two dies were typically used. The first die was approximately 5 mm in diameter, and when the dough was forced through the aperture, small sickle shaped pieces were formed by the cutter. Dimensions when dry were approximately 4-5 mm×8-12 mm×1.2-1.5 mm. The larger pieces were subsequently ground using a lab scale Perten Instruments laboratory disc type mill. The ground material was then sieved to remove fines, and fractions were combined to obtain an approximate 20-40 mesh product. The second die was a small circular die with a 1 mm aperture. This die created very small cylindrical pieces approximately 0.8 mm×1.5 mm when dried. The smaller die eliminated the need for further grinding and sieving.

### Example 2

### Agglomeration of Hydrocolloids

Approximately 4.5 kilos of hydrocolloid material was placed in a pilot plant agglomerator with a 5 kilo capacity. Solutions of dissolved carbohydrate(s) and/or a solution of a second hydrocolloid were prepared and pumped through a spray nozzle at the top of the agglomerator using a peristaltic pump. Temperatures for agglomeration ranged from approximately room temperature to 65° C. Solutions were prepared to result in final concentrations of second hydrocolloid in the finished agglomerated product that varied from 0.1 to 0.3%. Final concentrations of carbohydrates varied from 5 to 25%.

### Example 3

### Rheological/Viscosity Development as a Function of Time

Rheological tests were conducted using a Paar Physica Rheometer (#MCR 300, Anton-Paar, Austria) using a fixture designed for studying starch gelatinization (#C-ETD 160/ST). The fixture contains a probe with multiple blades attached to a transducer with which to measure torque. The probe was lowered into a small, temperature controlled cup at a standardized depth. The starch cell probe was rotated at 250 rpm at 20° C. for all tests conducted and the apparent viscosity (or torque) was recorded over time.

Samples of processed material were weighed in amounts that resulted in an approximately 1-3% solution of hydrocolloid. Two protocols were used in testing. The first used a solution of corn syrup and water to mimic a high solids food product such as a cookie or snack food, where limited water is available for hydration. While the second used corn syrup as a dispersant, followed by the addition of a small amount of water to mimic chewing with saliva and finally the addition of a large volume of water to mimic the swallowing and hydration which occurs in the stomach with stomach fluids.

A sampling of hydrocolloids were studied with a variety of carbohydrates. The hydrocolloids (pectin, psyllium, alginate/pectin blend, and alginate) were studied unprocessed, extruded alone, and coextruded with a carbohydrate (i.e., polydextrose, inulin, and isomalt).

Protocol 1: Hydration Over Time in a Limited Water System

0.54 g of sample (weight corrected for the amount of carbohydrate) was weighed on an analytical balance into the starch cell cup as a dry powder. To calculate the weight correction, the weight of the hydrocolloid was kept constant, therefore, if a carbohydrate was used, the overall weight of the sample was increased. For example, with a 25% carbohydrate:75% hydrocolloid, 0.72 g of product was used.

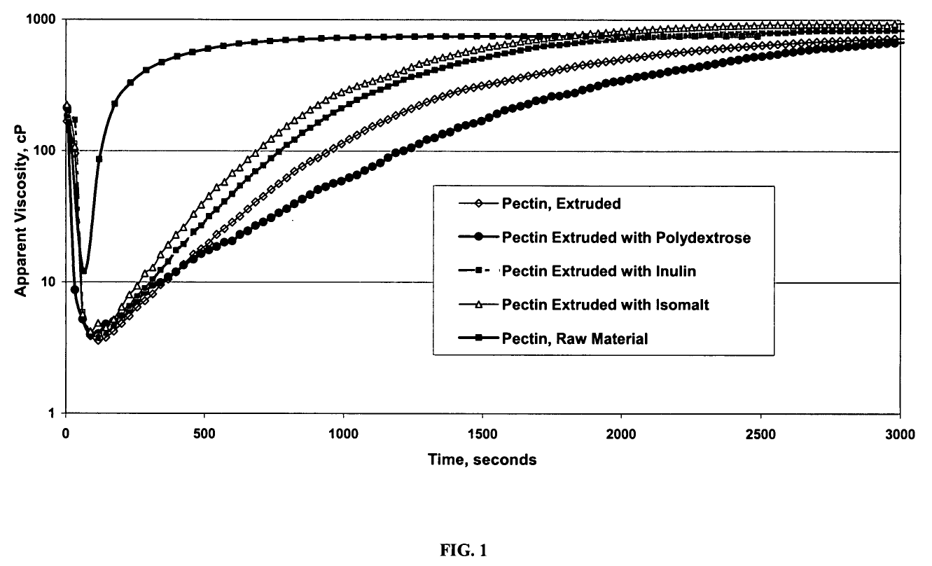

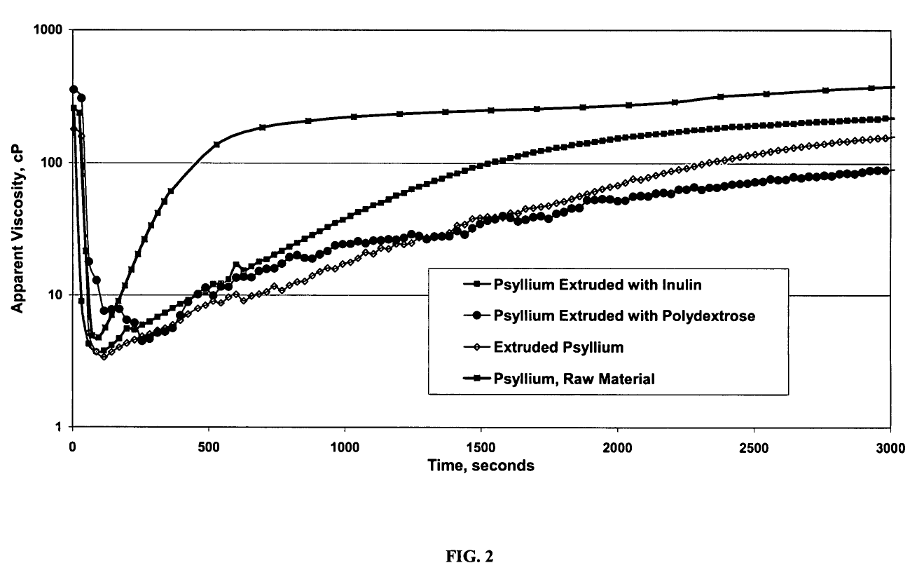

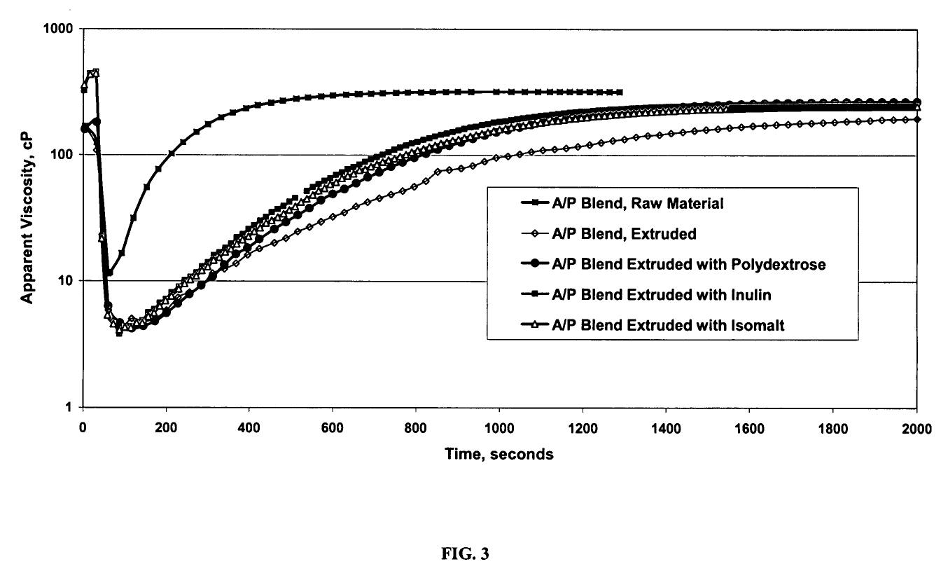

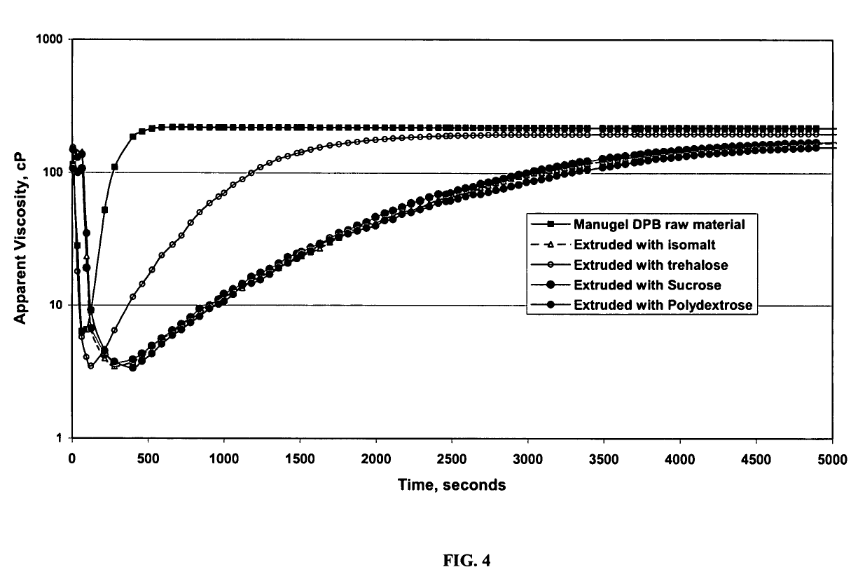

To the sample, 8.8 grams of corn syrup were added. The fixture cup was then placed into the rheometer temperature controlled well. The test was started and 20-30 seconds elapsed before the addition of 8.8 mL of water. Development of viscosity over time was monitored at a constant speed of 250 rpm from 30 minutes to over 2 hours, depending on the sample hydration kinetics. See FIGS. 1, 2, 3, and 4 for the results for pectin, psyllium, alginate/pectin blend, and alginate, respectively. The graphs illustrate that the raw, unprocessed material hydrates much more quickly than any of the processed materials. Some differences were observed between the carbohydrates used to create glassy matrices. Overall, polydextrose was found to be best able to slow hydration of the hydrocolloid, followed closely by inulin and isomalt, whose results varied based on the hydrocolloid studied.

Protocol 2: Chew and Swallow Hydration Measurement.

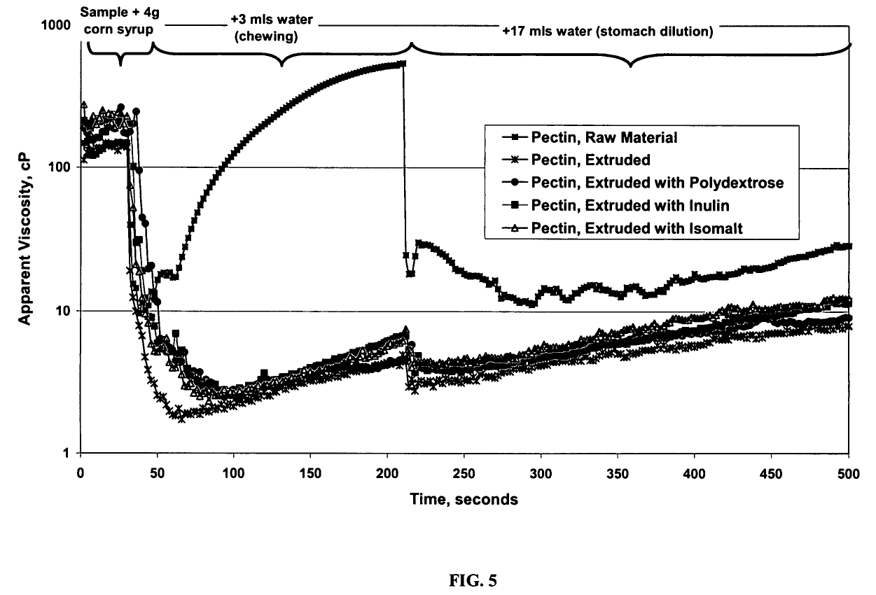

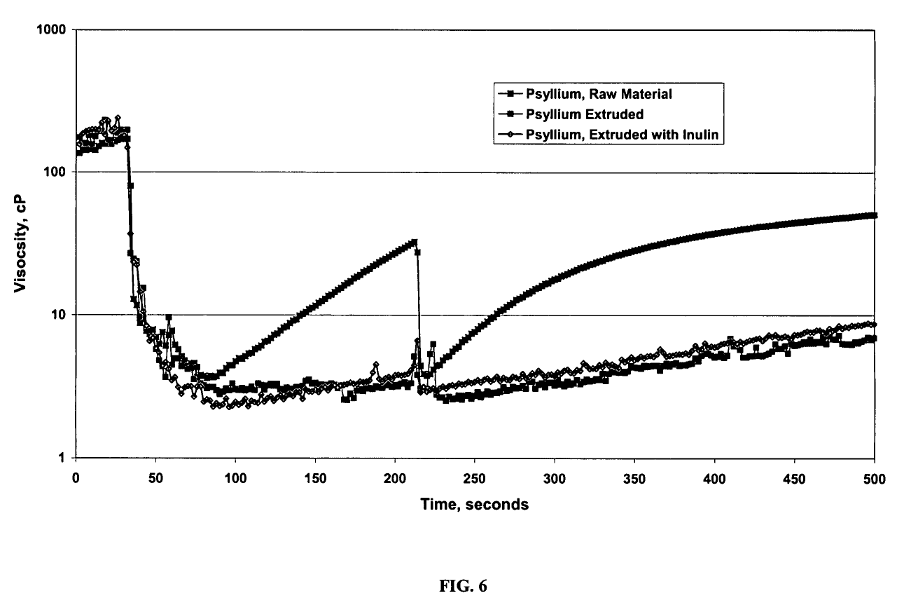

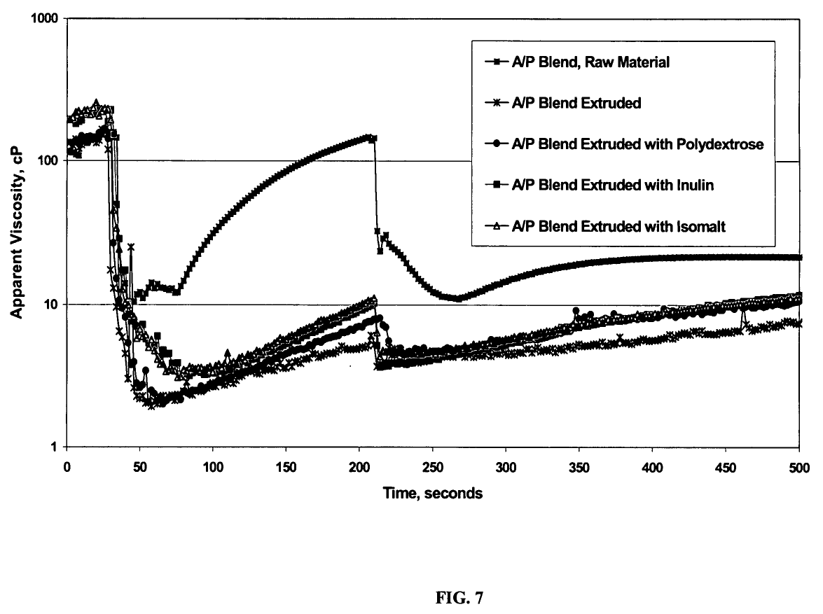

0.4 grams of sample (weight corrected for the amount of carbohydrate) was weighed on an analytical balance into the fixture cup. 4 grams of corn syrup was added and the cup placed in the rheometer. The test was started and allowed to mix for 30 seconds (to mimic dispersion of the hydrocolloid in a low solids food product). 4 mL of water was added and allowed to mix for an additional 3 minutes to mimic chewing with the addition of saliva and swallowing. 17 mL of water was then added to mimic hydration in the stomach with stomach fluids. The mixture was allowed to stir for 2 hours or until maximum viscosity was reached. See FIGS. 5, 6, and 7 for the results for pectin, psyllium and an alginate/pectin blend. This protocol demonstrates that the processing methods delay hydration in limited water situations and that the various carbohydrates produce only slightly different hydration kinetics. Overall, the various carbohydrates performed almost identically with all of the hydrocolloids studied, and in all cases significantly outperformed the unprocessed hydrocolloid materials. Additionally, it is shown that extrusion of products that are subsequently ground and dried hydrate differently (faster) than products that are extruded into a smaller particle size and not subsequently ground.

### Example 4

### Sorption Isotherms

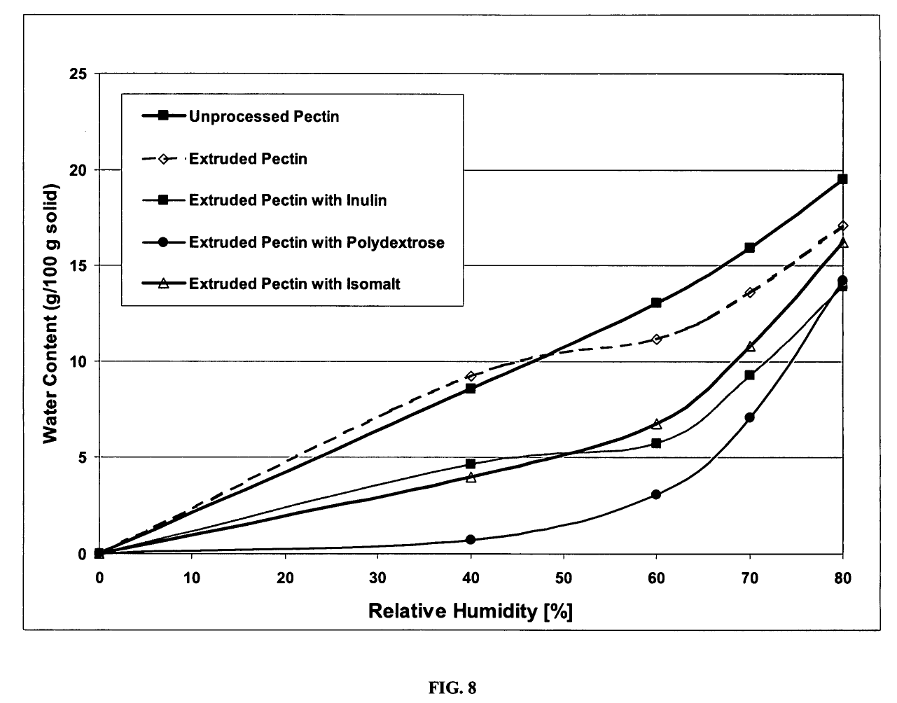

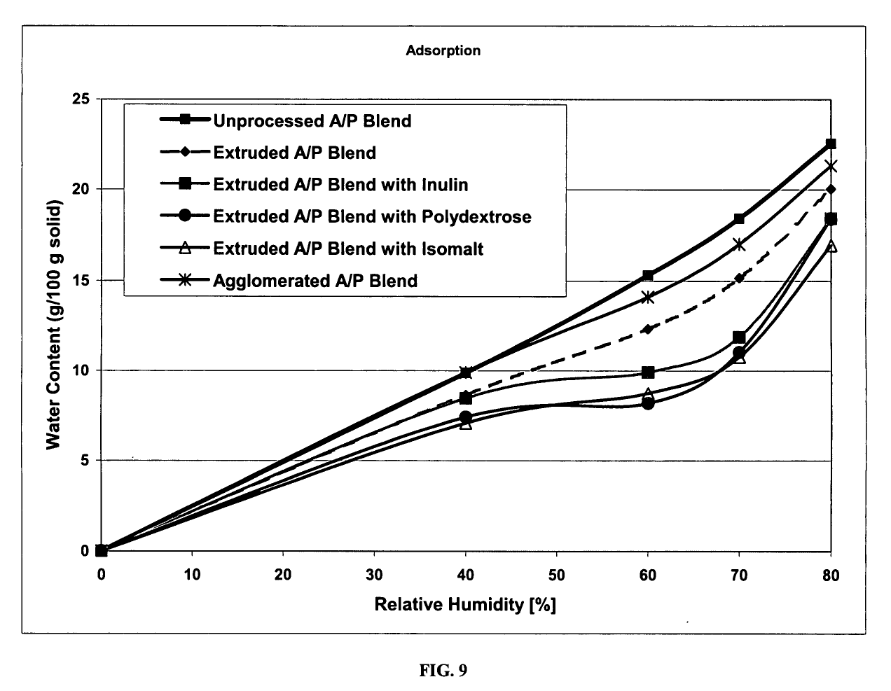

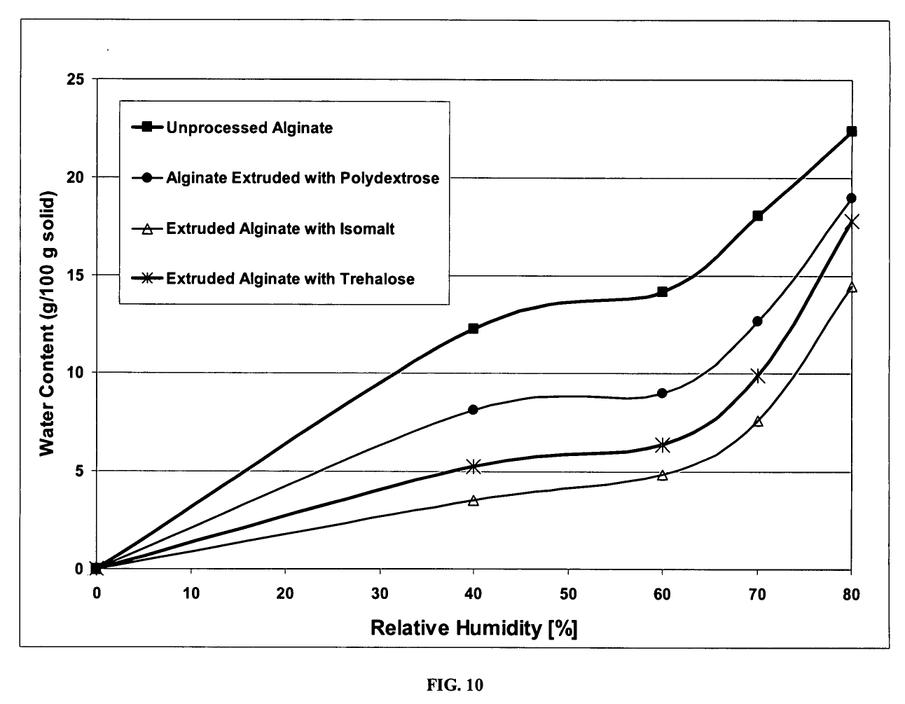

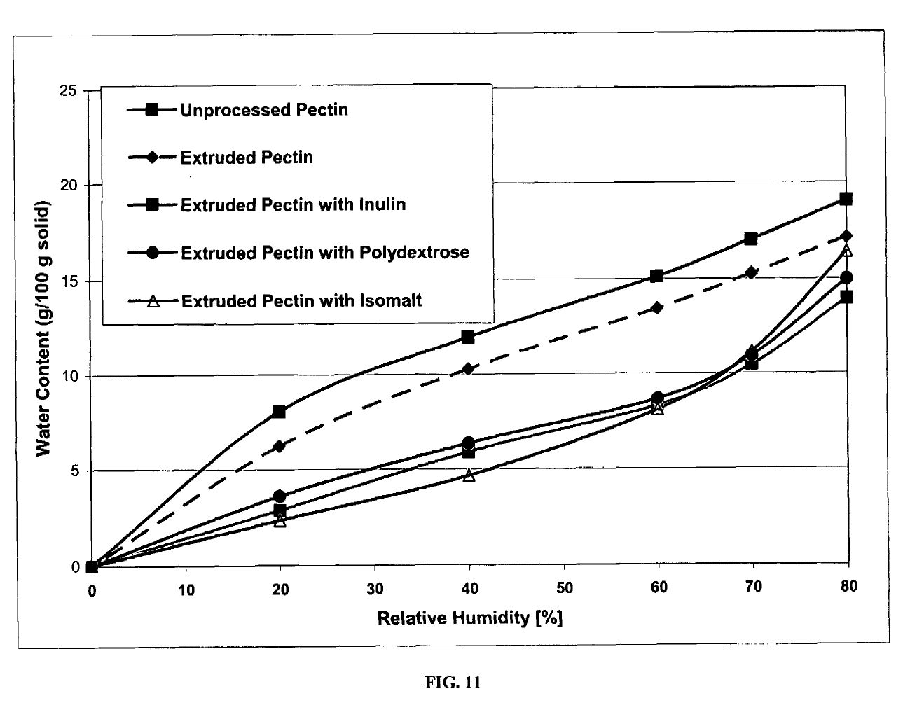

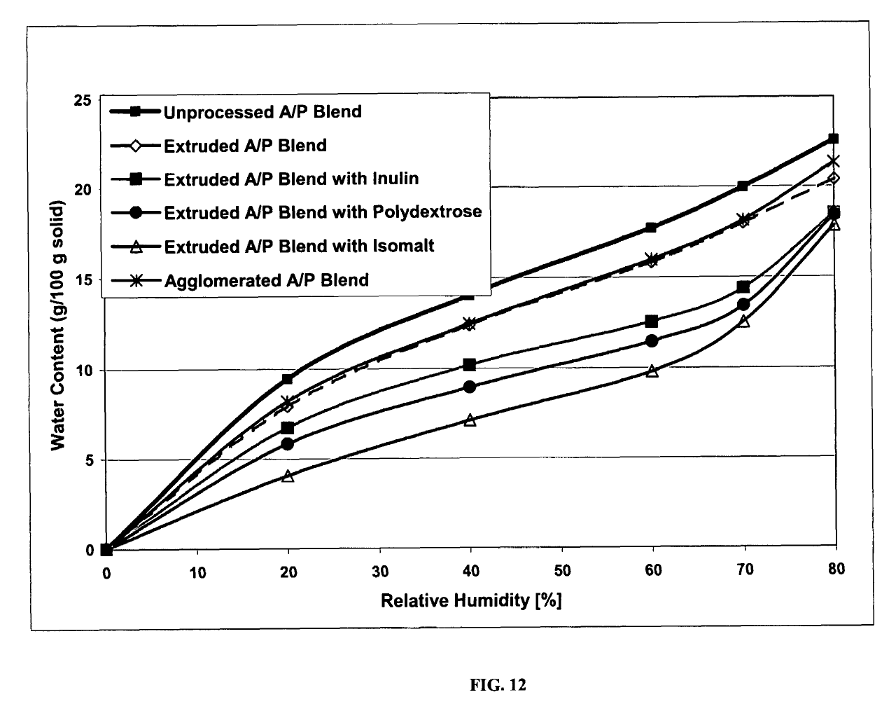

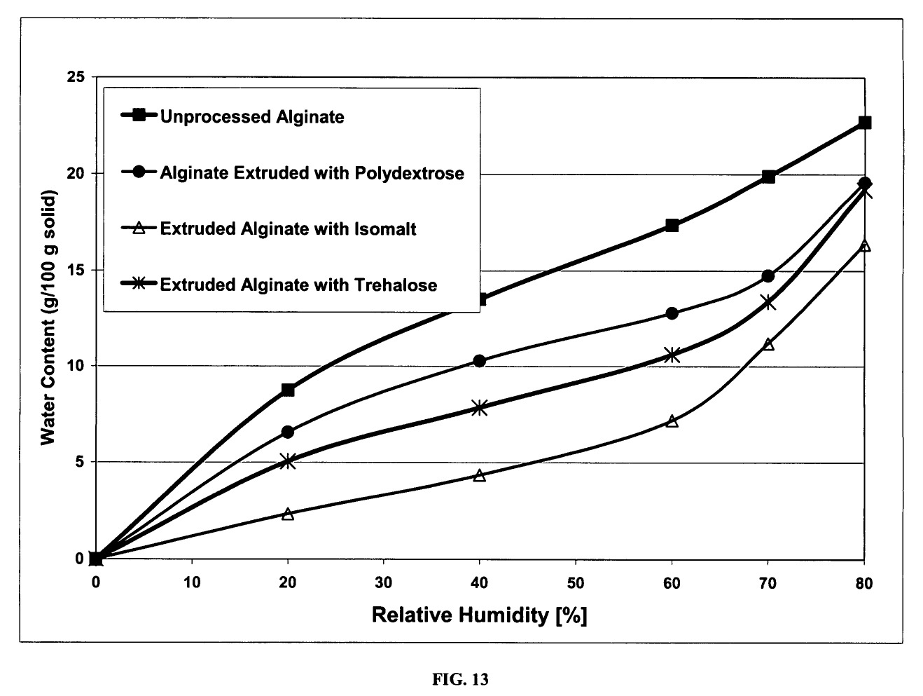

Sorption isotherms for co-processed (e.g., hydrocolloid extruded with carbohydrate) and unprocessed hydrocolloids were conducted using an IGA sorption isotherm instrument (Hiden Isochema, Warrington, England). The instrument generates a controlled relative humidity at a specified temperature and a microbalance records the weight gain (adsorption) or weight loss (desorption). Adsorption isotherms were conducted by holding a 10 mg sample with a relative humidity profile of 40, 60, 70, and 80% humidities. Desorption isotherms were conducted by holding the same sample at 80, 70, 60, 40, 20, and 0% relative humidities. The samples were held for approximately 3 hours at each relative humidity or until equilibrium was reached. Plots of the percent mass gained or lost (compared to the mass at 0% humidity) were constructed. Sorption isotherms for pectin, an alginate/pectin blend, and alginate were measured as unprocessed material, extruded alone, and coextruded with polydextrose, inulin or isomalt. Sorption isotherms for the three hydrocolloids are shown in FIGS. 8, 9, and 10 while desorption isotherms are shown in FIGS. 11, 12 and 13.

Whether absorbing or desorbing water, the extruded hydrocolloid compositions containing the various carbohydrates outperformed their unprocessed or hydrocolloid only counterparts. The carbohydrate/hydrocolloid compositions delayed the rate of hydration and similarly were able to lose water much more efficiently. Overall, there were slight differences among the carbohydrates depending on which hydrocolloid they were extruded with. For example, with pectin, the relative rates of absorption for the various carbohydrates were polydextrose>isomalt=inulin, for the alginate/pectin blend, the rates for hydration for the various carbohydrates resulted in isomalt=polydextrose>inulin, while for straight alginate, the rates for hydration were isomalt>inulin>polydextrose.

### Example 5

### Glass Transition Measurement

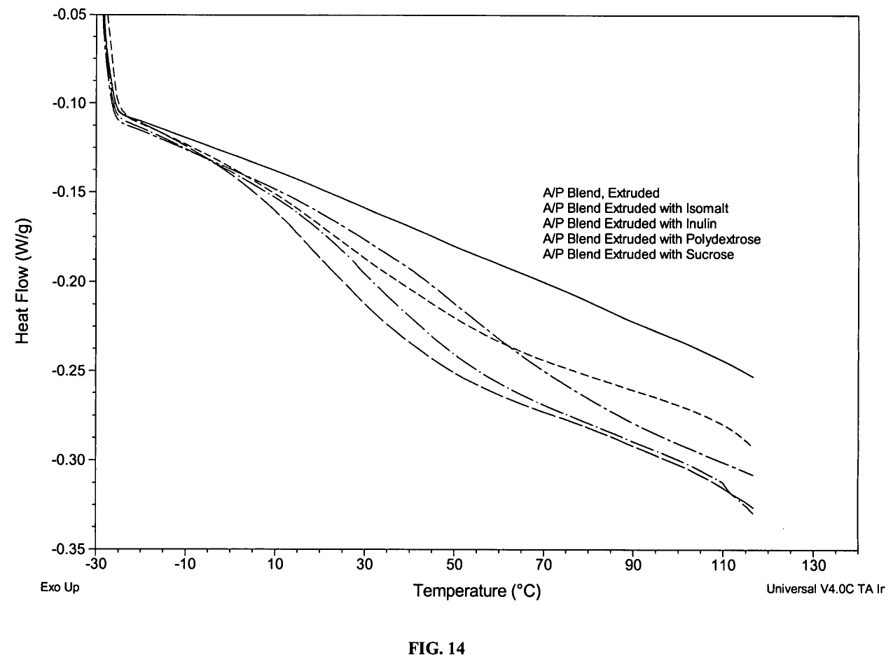

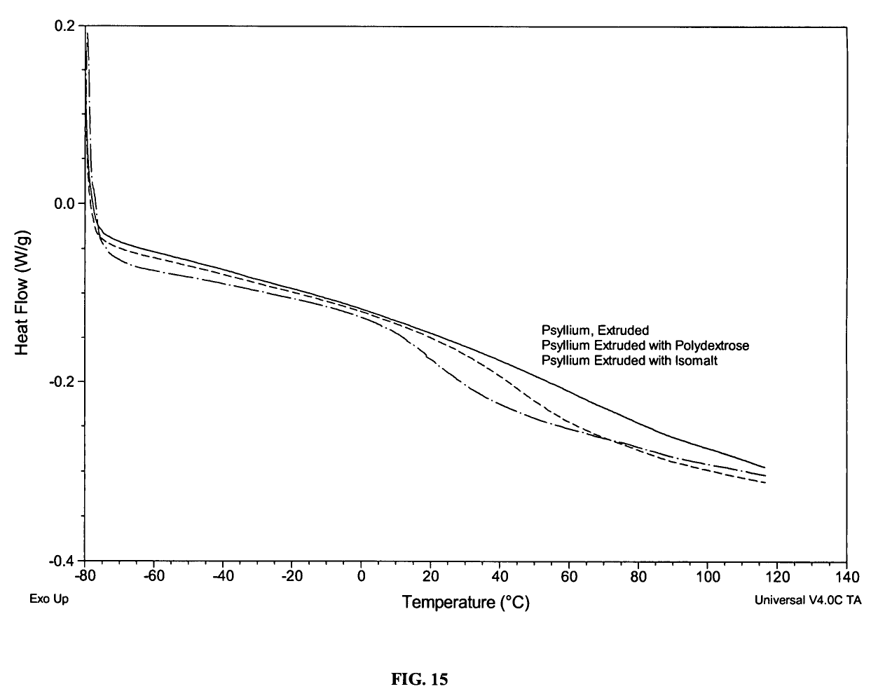

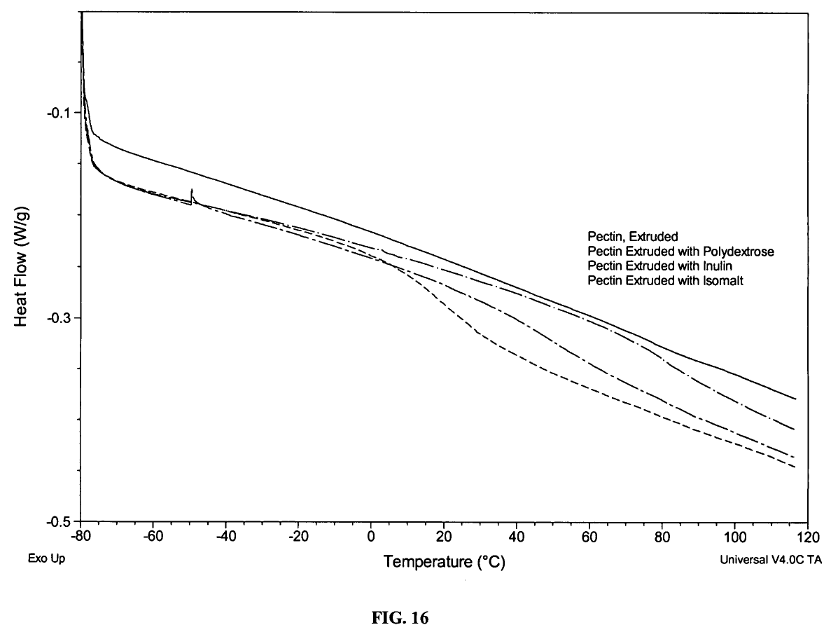

Glass transitions of various samples were measured using a Differential Scanning Calorimeter (Q1000, TA Instruments, New Castle, Del.). Samples included an alginate/pectin blend, psyllium husk fiber, and pectin. All samples were measured after being extruded alone and with various carbohydrates (e.g., polydextrose, isomalt, inulin, and sucrose). To measure the glass transition temperatures 6-10 mg were weighed into a hermetically sealed pan. The samples were run using a thermal profile of 10° C./minute from 25° C. to 80° C. to erase thermal history, cooled to either −80° C. or −30° C. and then scanned to 120° C. See FIGS. 14, 15, and 16. The glass transition was demonstrated as a change in heat capacity over a wide temperature range. No such changes were observed with material extruded alone or with unprocessed material.

### Example 6

### Particle Size Dissolution

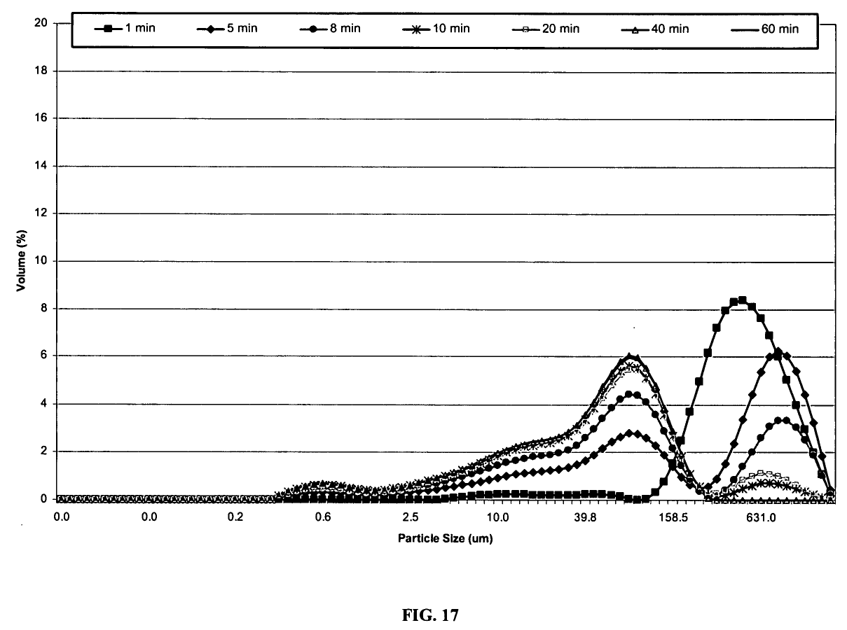

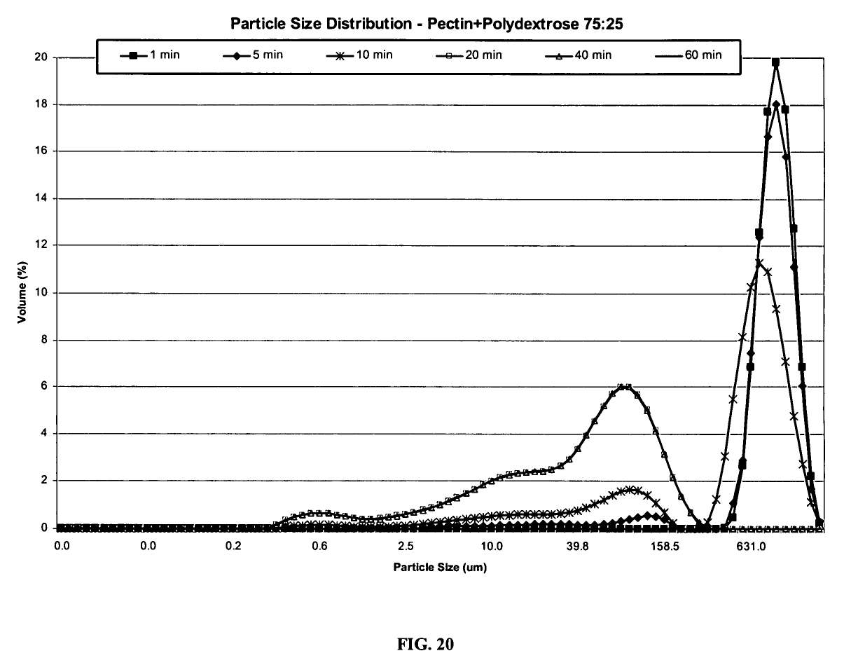

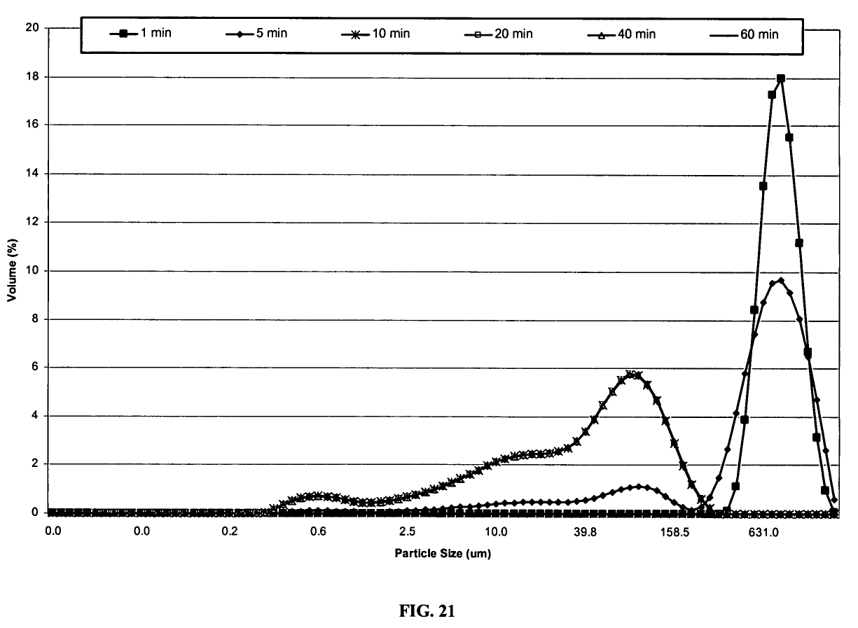

To study dissolution differences, a Mastersizer 2000 from Malvern Instruments (Malvern, UK) was used. The instrument measures the particle size distribution (PSD) of a material by laser diffraction and calculates the PSD using the Mie theory. Samples of pectin (unextruded, extruded alone, and extruded with polydextrose, inulin, and isomalt) were add directly to demineralized water at concentrations of 0.27% to 0.33%, and the sample was stirred at 3500 rpm. Particle size was measured every minute for ten minutes and every 20 minutes thereafter. Only data for the 1, 5, 10, 20, 40, and 60 minute time periods are shown in FIG. 17-21 for clarity. An 8 minute point was included for both the unprocessed pectin and extruded pectin.

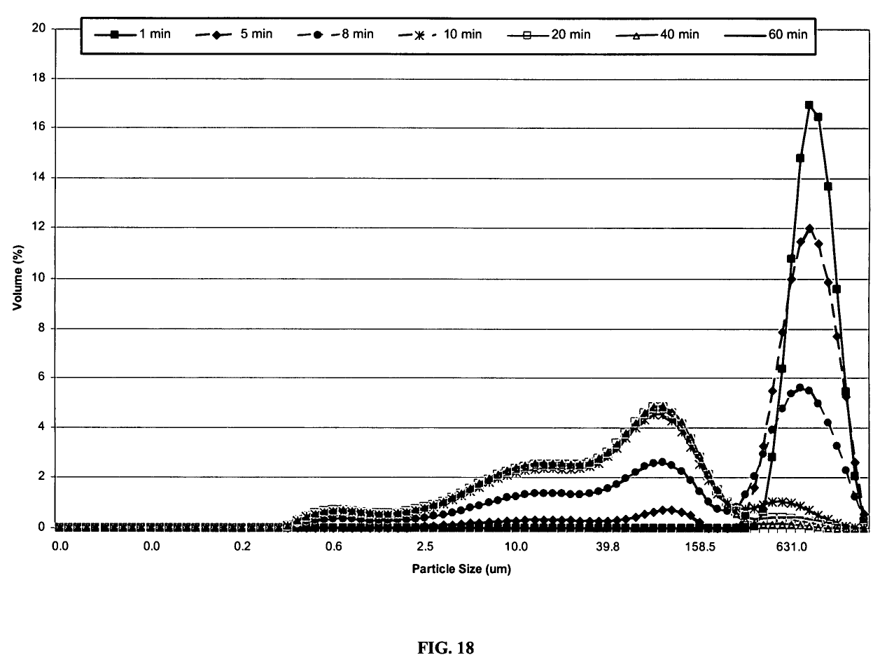

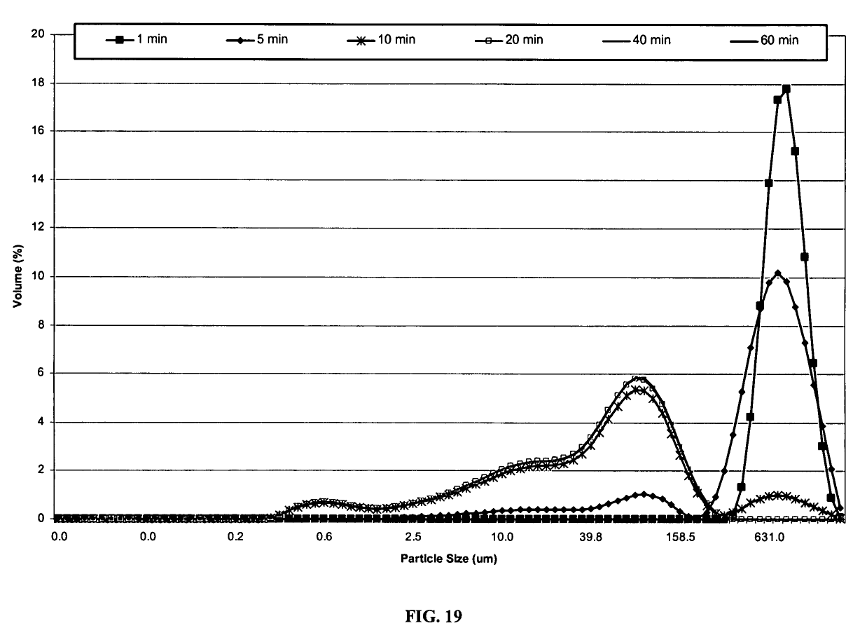

Unprocessed pectin lumped and created “fisheyes” in this experiment, and this effect can be seen in FIG. 17 as the particle size increased for the 5, 8, 10, and 20 minute time points. None of the other extruded products exhibited this behavior and in those cases, the particle size decreased rapidly over time. Extruded pectin (FIG. 18) took longer to decrease in particle size than any of the other pectin samples extruded with 25% isomalt, polydextrose, or inulin (FIGS. 19, 20, and 21). Within the set of the three carbohydrates, isomalt particle size decreased most readily, inulin particle size decreased at a slightly slower rate, and a decrease in particle size for polydextrose took the longest, with a sizeable amount of larger particles still present after 10 minutes.

This data follows the trends demonstrated by the hydration curves, as shown by the longer times required to dissolve polydextrose in comparison to inulin or isomalt.

### Example 7

### Dry Foods Incorporating Hydrocolloid Compositions

A rotary molded cookie prototype (golden crisp cookie) and a pretzel snack product were prepared. The products were prepared with the ingredients in the manner described below.

A. Golden Crisp Rotary Molded Cookies Formulation and Preparation

TABLE 1
Rotary Molded Style, Golden Crisp Cookies

| | Extruded | | Extruded | |
|---|---|---|---|---|
| | Pectin | | Psyllium | |
| Ingredients | % | grams | % | grams |
| flour | 32.0 | 160.0 | 32.0 | 160.0 |
| vegetable oil | 8.8 | 44.0 | 8.8 | 44.0 |
| lecithin | 1.0 | 5.0 | 1.0 | 5.0 |
| corn starch | 4.0 | 20.0 | 4.0 | 20.0 |
| inulin | 6.0 | 30.0 | 6.0 | 30.0 |
| granulated sugar | 6.3 | 31.5 | 6.3 | 31.5 |
| brown sugar | 5.0 | 25.0 | 5.0 | 25.0 |
| corn syrup, 42 DE | 2.0 | 10.0 | 2.0 | 10.0 |
| condensed milk | 2.4 | 12.0 | 2.4 | 12.0 |
| sodium bicarbonate | 0.4 | 2.0 | 0.4 | 2.0 |
| ammonium bicarbonate | 0.3 | 1.5 | 0.3 | 1.5 |
| acid cream powder | 0.1 | 0.5 | 0.1 | 0.5 |
| salt | 0.7 | 3.5 | 0.7 | 3.5 |
| oats, fine ground | 8.0 | 40.0 | 8.0 | 40.0 |
| water | 9.0 | 45.0 | 9.0 | 45.0 |
| polydextrose, Danisco Ultra | | | | |
| Litesse | | | | |
| extruded pectin/polydextrose | 14.0 | 70.0 | | |
| extruded psyllium/polydextrose | | | 14.0 | 70.0 |
| Total | 100.0 | 500.0 | 100.0 | 500.0 |

The cookies were produced by mixing the sugars, inulin, and vegetable oil for 1 minute at speed 2 in a Hobart mixer fitted with a paddle attachment. Liquid ingredients (corn syrup, condensed milk, water) were mixed with the ammonium bicarbonate and then added to the sugar/oil blend. These were blended for 30 seconds at speed 2. The remaining dry ingredients were blended and then added to the Hobart mixture, mixed at speed 1 for approximately 1 minute. The dough was then quickly rolled out and a 2½ inch cookie cutter was used to stamp out the cookies. Cookies were baked on parchment paper for 14 minutes at 350° F.

B. Pretzel Formulation and Preparation

TABLE 2
Pretzel Formulation.

Extruded
Pectin

| Ingredients | % | grams |
|---|---|---|
| pastry flour | 48.00 | 240.0 |
| water | 27.43 | 137.1 |
| soybean oil | 1.71 | 8.6 |
| corn syrup | 1.71 | 8.6 |
| compressed yeast | 0.51 | 2.6 |
| baking powder | 0.05 | 0.3 |
| extruded pectin/polydextrose | 20.57 | 102.9 |
| Total | 100 | 500 |

The pretzels were prepared by mixing all ingredients together in a Hobart mixer fitted with a paddle attachment just until blended. The mixture was then extruded through a small grinder plate attachment. The “strings” of dough were then placed in a sodium hydroxide bath (1.25%) for approximately 5 seconds, placed on parchment paper, sprinkled with salt and baked at 400° F. for 12 minutes.

### Example 8

### Sensory Evaluation for Slime and Mouth Feel

Incorporation of large amounts of hydrocolloids into a dry food product can have a detrimental impact on its organoleptic properties. In particular, hydrocolloids tend to impart a slimy or viscous property to a food product during mastication. Without being bound by theory, it is believed that hydrating hydrocolloids in the mouth can bind to the teeth and the oral soft tissues, resulting in a viscous coating layer that is sensed as having a slimy quality. Sliminess of a product can be measured by a subjective sensory test. Tooth packing is the adherence of product to the teeth, particularly the crevices in the crowns of the molars, as well as adherence to teeth at the gingival margins (gum packing). Without being bound by theory, it is believed that mastication forces food particles into the crown crevices and gingival margins, and the mass is held in place by the viscous and adhesive properties of the soluble fiber. Creation of products with decreased slime, tooth and gum packing scores is highly preferred, since this will enhance consumer acceptability.

A sensory evaluation of sliminess, tooth pack, and gum pack of such products was performed by having a trained sensory panel chew a specific weight of the product and assign a numeric score to the amount of mouth sliminess or tooth and gum packing sensed after mastication. The product was then expectorated, and the mouth rinsed with water. A sensory evaluation was then performed again. Tooth and gum packing was similarly evaluated before and after rinsing. A final assessment for slime was performed to evaluate the delayed response in the formation of a slime sensation. A control product was used as a standard, and arbitrarily assigned a score of, e.g., 30 units. If a test product produced a very small difference in slime (either an increase or decrease), it was assigned a score that was, e.g., 5-6 units different. Therefore, a product that was slightly less slimy than the control would have a score of 25, and a product that was slightly more slimy than the control would have a score of 35. A large difference in slime (either more or less) would be assigned a score 15-20 units different from the control. A huge difference in slime would be reflected in a score that was 30 points different than the control. A similar scale was used for the evaluation of tooth and gum packing. Therefore, an ideal product would have a slime score of about 0, and a similar score for tooth and gum packing.

A. Cookie Containing Unprocessed High Molecular Weight Alginate

TABLE 3
Cookie Formulation with Unprocessed High Molecular Weight Alginate

| | | | % Final | |
|---|---|---|---|---|
| Ingredient | Supplier | % Dough | Formulation | Amount (grams) |
| Soybean Oil | Crisco | 10.500 | 6.169 | 42.00 |
| Vitamin E | Eastman | 0.0036 | 0.0021 | 0.0144 |
| Sugar (Fine Granulated) | MI Sugar | 18.200 | 10.693 | 72.80 |
| Water | Domestic | 8.830 | 5.188 | 35.32 |
| Molasses, Black Strap | International | 2.400 | 1.410 | 9.60 |
| | Sweeteners | | | |
| Sucralose, 25% Solution | Tate and Lyle | 0.264 | 0.160 | 1.06 |
| Lecithin, Yelkin TM | ADM | 0.750 | 0.441 | 3.00 |
| Vanilla N&A 597970 T | Firminich | 0.800 | 0.470 | 3.20 |
| Flour, Cookie | Minnel Milling | 17.500 | 10.282 | 70.00 |
| Baking Soda | Church & Dwight | 0.250 | 0.147 | 1.00 |
| Quick Rolled Oats | Can-Oat Milling | 18.786 | 11.037 | 75.14 |
| High Molecular Weight | ISP Manugel DPB | 18.237 | 10.715 | 72.95 |
| Alginate | | | | |
| Glycerol, Superol 99.7% | P&G | 3.500 | 2.056 | 14.00 |
| Total | | 100.00 | 58.77 | 400.00 |

Cookies were prepared as described in Example 7.

B. Cookie Comprising Extruded High Molecular Weight Alginate

TABLE 4
Cookie Formulation Comprising Extruded High Molecular Weight Alginate

| | | % | % Final | |
|---|---|---|---|---|
| Ingredient | Supplier | Dough | Formulation | Amount (grams) |
| Soybean Oil | Crisco | 10.500 | 6.17 | 42.00 |
| Vitamin E | Eastman | 0.0036 | 0.002 | 0.0144 |
| Sugar (Fine Granulated) | MI Sugar | 18.200 | 10.693 | 72.80 |
| Water | Domestic | 6.430 | 3.778 | 25.72 |
| Molasses, Black Strap | International | 2.400 | 1.410 | 9.60 |
| | Sweeteners | | | |
| Sucralose, 25% Solution | Tate and Lyle | 0.264 | 0.16 | 1.06 (??) |
| Lecithin, Yelkin TM | ADM | 0.750 | 0.441 | 3.00 |
| Vanilla N&A 597970 T | Firminich | 0.800 | 0.470 | 3.20 |
| Flour, Cookie | Minnel Milling | 13.800 | 8.108 | 55.20 |
| Baking Soda | Church & Dwight | 0.250 | 0.147 | 1.00 |
| Quick Rolled Oats | Can-Oat Milling | 18.786 | 11.037 | 75.14 |
| High Molecular Weight | | 24.316 | 14.286 | 97.26 |
| Alginate Blend | | | | |
| Glycerol, Superol 99.7% | P&G | 3.500 | 2.056 | 14.00 |
| Total | | 100.00 | 58.75 | 400.00 |

Cookies were prepared as described in Example 6.

The two cookie compositions disclosed above were evaluated by a person skilled in the art for dough lay time and slime. Results are presented in the following tables.

TABLE 5
Dough Lay Time (Minutes)

| Composition | 0 | 15 | 30 | 45 | Comments |
|---|---|---|---|---|---|
| Unprocessed High | 7.0 | 6.0 | 6.0 | 5.5 | Cohesive, but |
| Molecular Weight | | | | | sticky soft, |
| Alginate | | | | | slightly oily |
| Extruded High | 7.0 | 6.0 | 4.5 | <4.0 | Dried rapidly |
| Molecular Weight | | | | | |
| Alginate | | | | | |

TABLE 6
Slime Evaluation

| | Mouth Coating | | | Tooth Packing | |
|---|---|---|---|---|---|
| | Before | After | Delayed | Before | After |
| Composition | Rinsing | Rinsing | Response | Rinsing | Rinsing |
| Unprocessed High | 20 | 25 | 30 | 25–30 | 30 |
| Molecular Weight | | | | | |
| Alginate | | | | | |
| Processed High | 15 | 10 | 20 | 15 | 25 |
| Molecular Weight | | | | | |
| Alginate | | | | | |

The cookie made with the extruded hydrocolloid composition displayed improvement in dough lay time, in comparison to the cookie made with the unprocessed control hydrocolloid. Importantly, the dough was still processable at 45 minutes, which is important in commercial baking as this permits larger batch sizes, and allows the dough to still be used after brief equipment interruptions.

The cookie made with the extruded hydrocolloid composition also displayed marked improvements in mouth coating and tooth packing. These improvements are sufficient to make a dry food product acceptable to consumers, whereas a similar dry food product made with the unprocessed hydrocolloid would be viewed as unacceptable.

What is claimed is:

1. A composition comprising a hydrocolloid agglomerated with a carbohydrate and/or a second hydrocolloid.

2. A composition comprising a hydrocolloid extruded with a carbohydrate and/or a second hydrocolloid, wherein said carbohydrate is selected from arabinose, ribose, xylose, xylitol, fructose, galactose, glucose, mannose, sorbitol, sucrose, trehalose, isomalt, lactose, maltose, maltitol, mannitol, erythritol, ribulose, tagatose, lactitol, cellobiose, and mixtures thereof.

3. The composition of claim 1, wherein said carbohydrate and/or second hydrocolloid is in aqueous solution.

4. The composition of claim 2, wherein said carbohydrate and/or second hydrocolloid is in aqueous solution.

5. The composition of claim 1 or 2, wherein said composition is unground.

6. The composition of claim 1 or 2, wherein said composition comprises a glassy matrix.

7. The composition of claim 1 or 2, wherein at least a portion of said carbohydrate is in the form of a glassy matrix.

8. The composition of claim 1 or 2, wherein said hydrocolloid is selected from xanthan gum, guar gum, locust bean gum, gelatin, carrageenan, polygeenan, alginate, pectin, psyllium husk fiber, agar, beta glucan, gellan gum, konjac, carob bean gum, gum Arabic, ghatti gum, karaya gum, tara gum, tragacanth gum, gellan, methyl cellulose, hydroxypropylmethyl cellulose, chitosan, chitin, propylene glycol alginate, and mixtures thereof.

9. The composition of claim 8, wherein said hydrocolloid is selected from alginate, pectin, and psyllium husk fiber.

10. The composition of claim 8, wherein said hydrocolloid is a blend of alginate and pectin.

11. The composition of claim 10, wherein said alginate comprises an intermediate molecular weight distribution range form of alginate and a low molecular weight distribution range form of alginate.

12. The composition of claim 11, wherein a ratio of said intermediate molecular weight alginate to said low molecular weight alginate is about 0.65:1 to about 2:1.

13. The composition of claim 12, wherein said ratio of said intermediate weight alginate to said low molecular weight alginate is about 0.8:1 to about 0.9:1.

14. The composition of claim 10, wherein a ratio of total alginate to total pectin can be from about 8:1 to about 1:8.

15. The composition of claim 14, wherein said ratio of total alginate to total pectin is about 7:1.

16. The composition of claim 15, wherein said ratio of total alginate to total pectin is about 6.15:1.

17. The composition of claim 9, wherein said hydrocolloid is alginate.

18. The composition of claim 17, wherein said alginate is high molecular weight alginate.

19. The composition of claim 1, wherein said carbohydrate is selected from arabinose, ribose, xylose, xylitol, fructose, galactose, glucose, mannose, sorbitol, sucrose, trehalose, isomalt, lactose, maltose, maltitol, mannitol, erythritol, ribulose, tagatose, lactitol, cellobiose, polydextrose, inulin, corn dextrin, and wheat dextrin.

20. The composition of claim 19, wherein said carbohydrate is selected from polydextrose, inulin, isomalt, trehalose, and sucrose.

21. The composition of claim 20, wherein said carbohydrate is polydextrose.

22. The composition of claim 1 or 2, wherein a ratio of total hydrocolloid to total carbohydrate is about 95:5 to about 10:90 by weight.

23. The composition of claim 22, wherein said ratio of total hydrocolloid to total carbohydrate is about 90:10 to about 60:40.

24. The composition of claim 23, wherein said ratio of total hydrocolloid to total carbohydrate is about 85:15.

25. The composition of claim 23, wherein said ratio of total hydrocolloid to total carbohydrate is about 75:25.

26. The composition of claim 1, wherein said hydrocolloid comprises a blend of alginate and pectin, and wherein said carbohydrate comprises polydextrose.

27. The composition of claim 1 or 2, wherein said second hydrocolloid is selected from xanthan gum, guar gum, locust bean gum, gelatin, carrageenan, polygeenan, alginate, pectin, psyllium husk fiber, agar, beta glucan, gellan gum, konjac, carob bean gum, gum Arabic, ghatti gum, karaya gum, tara gum, tragacanth gum, gellan, methyl cellulose, hydroxypropylmethyl cellulose, chitosan, chitin, propylene glycol alginate, and mixtures thereof.

28. The composition of claim 27, wherein said second hydrocolloid is selected from xanthan and pectin.

29. A method of making a composition comprising an extruded hydrocolloid, said method comprising:
a) providing a hydrocolloid; and
b) cold extruding said hydrocolloid with a second hydrocolloid and/or a carbohydrate, wherein said carbohydrate is selected from arabinose, ribose, xylose, xylitol, fructose, galactose, glucose, mannose, sorbitol, sucrose, trehalose, isomalt, lactose, maltose, maltitol, mannitol, erythritol, ribulose, tagatose, lactitol, cellobiose, and mixtures thereof.

30. The method of claim 29, wherein said hydrocolloid is selected from xanthan gum, guar gum, locust bean gum, gelatin, carrageenan, polygeenan, alginate, pectin, psyllium husk fiber, agar, beta glucan, gellan gum, konjac, carob bean gum, gum Arabic, ghatti gum, karaya gum, tara gum, tragacanth gum, gellan, methyl cellulose, hydroxypropylmethyl cellulose, chitosan, chitin, propylene glycol alginate, and mixtures thereof.

31. The method of claim 30, wherein said hydrocolloid is selected from alginate, pectin, and psyllium husk fiber.

32. The method of claim 31, wherein said hydrocolloid is a blend of alginate and pectin.

33. The method of claim 29, wherein said second hydrocolloid is selected from xanthan gum, guar gum, locust bean gum, gelatin, carrageenan, polygeenan, alginate, pectin, psyllium husk fiber, agar, beta glucan, gellan gum, konjac, carob bean gum, gum Arabic, ghatti gum, karaya gum, tara gum, tragacanth gum, gellan, methyl cellulose, hydroxypropylmethyl cellulose, chitosan, chitin, propylene glycol alginate, and mixtures thereof.

34. The method of claim 33, wherein said second hydrocolloid is selected from xanthan and pectin.

35. The method of claim 29, wherein said carbohydrate and/or second hydrocolloid is in aqueous solution.

36. The method of claim 29, wherein said carbohydrate is selected from sucrose and trehalose.

37. The method of claim 29, wherein said cold extrusion occurs at from about 35° C. to about 80° C.

38. The method of claim 29, wherein said hydrocolloid is dry.

39. A method of making a composition comprising an agglomerated hydrocolloid, said method comprising:
a) providing a hydrocolloid; and
b) agglomerating said hydrocolloid with a solution comprising a second hydrocolloid and/or a carbohydrate.

40. The method of claim 39, wherein said agglomeration occurs at a temperature from about 25° C. to about 65° C.

41. The method of claim 39, wherein said hydrocolloid is selected from xanthan gum, guar gum, locust bean gum, gelatin, carrageenan, polygeenan, alginate, pectin, psyllium husk fiber, agar, beta glucan, gellan gum, konjac, carob bean gum, gum Arabic, ghatti gum, karaya gum, tara gum, tragacanth gum, gellan, methyl cellulose, hydroxypropylmethyl cellulose, chitosan, chitin, propylene glycol alginate, and mixtures thereof.

42. The method of claim 39, wherein said hydrocolloid is selected from alginate, pectin, and psyllium husk fiber.

43. The method of claim 42, wherein said hydrocolloid is a blend of alginate and pectin.

44. The method of claim 39, wherein said carbohydrate is selected from arabinose, ribose, xylose, xylitol, fructose, galactose, glucose, mannose, sorbitol, sucrose, trehalose, isomalt, lactose, maltose, maltitol, mannitol, erythritol, ribulose, tagatose, lactitol, cellobiose, polydextrose, inulin, corn dextrin, wheat dextrin, and mixtures thereof.

45. The method of claim 44, wherein said carbohydrate is selected from polydextrose, inulin, isomalt, trehalose, and sucrose.

46. The method of claim 45, wherein said carbohydrate is polydextrose.

47. The method of claim 39, wherein said hydrocolloid comprises a blend of alginate and pectin, and wherein said carbohydrate comprises polydextrose.

48. The method of claim 39, wherein said second hydrocolloid is selected from xanthan gum, guar gum, locust bean gum, gelatin, carrageenan, polygeenan, alginate, pectin, psyllium husk fiber, agar, beta glucan, gellan gum, konjac, carob bean gum, gum Arabic, ghatti gum, karaya gum, tara gum, tragacanth gum, gellan, methyl cellulose, hydroxypropylmethyl cellulose, chitosan, chitin, propylene glycol alginate, and mixtures thereof.

49. The method of claim 48, wherein said second hydrocolloid is selected from xanthan and pectin.

50. The method of claim 39, wherein said hydrocolloid is dry.

51. The method of claim 39, wherein said solution is an aqueous solution.

52. A method of making a dry food product, said method comprising:
a) cold extruding a hydrocolloid with a second hydrocolloid and/or a carbohydrate, wherein said carbohydrate is selected from arabinose, ribose, xylose, xylitol, fructose, galactose, glucose, mannose, sorbitol, sucrose, trehalose, isomalt, lactose, maltose, maltitol, mannitol, erythritol, ribulose, tagatose, lactitol, cellobiose, and mixtures thereof; and
b) combining the extruded hydrocolloid composition with other food ingredients to prepare the dry food product.

53. A method of making a dry food product, said method comprising:
a) agglomerating a hydrocolloid with a solution comprising a second hydrocolloid and/or carbohydrate; and
b) combining the agglomerated composition with other food ingredients to prepare the dry food product.

54. The method of claims 52 or 53, wherein said dry food product is selected from the group consisting of cookies, bars, breads, tortillas, crackers, cereals, pretzels, muffins, confectionary products, and snack foods.

55. The method of claims 52 and 53, wherein the addition of said hydrocolloid composition does not adversely affect an organoleptic property of the food product.

56. A method of delaying hydration of a hydrocolloid in a dry food product, said method comprising incorporating into the food product a composition comprising a hydrocolloid extruded or agglomerated with a carbohydrate and/or a second hydrocolloid.

57. A method of altering an organoleptic property of a dough or dry food product, said method comprising incorporating into the dough or food product a composition comprising a hydrocolloid extruded or agglomerated with a carbohydrate and/or a second hydrocolloid.

58. The method of claim 57, wherein said organoleptic property is selected from a mechanical property, geometrical property, and moisture property.

59. The method of claim 58, wherein said mechanical property is selected from hardness, cohesiveness, springiness, and adhesiveness.

60. The method of claim 58, wherein said geometrical property is selected from particle size and shape, and general shape and orientation.

61. The method of claim 58, wherein said moisture property is selected from moistness, moisture release, oiliness, and greasiness.

62. The method of claim 57, wherein said organoleptic property is tooth pack.

63. The method of claim 57, wherein said organoleptic property is gum pack.

64. The method of claim 57, wherein said organoleptic property is sliminess.

65. The method of claim 57, wherein said dry food product is selected from the group consisting of cookies, bars, breads, tortillas, crackers, cereals, pretzels, muffins, confectionary products, and snack foods.

66. A method of improving the processability of a dough comprising a hydrocolloid, said method comprising incorporating into the dough a hydrocolloid extruded or agglomerated with a carbohydrate and/or a second hydrocolloid.

67. The method of claim 66, wherein said improvement in processability is dough lay time.

68. The method of claim 66, wherein said improvement in processability is delayed hydration of the hydrocolloid.

69. The method of claim 66, wherein said improvement in processability is as compared to a comparable dough comprising a hydrocolloid not extruded or not agglomerated with a carbohydrate and/or a second hydrocolloid.

70. A composition prepared by a process comprising:
a) providing a hydrocolloid; and
b) cold extruding said hydrocolloid with a second hydrocolloid and/or carbohydrate, wherein said carbohydrate is selected from arabinose, ribose, xylose, xylitol, fructose, galactose, glucose, mannose, sorbitol, sucrose, trehalose, isomalt, lactose, maltose, maltitol, mannitol, erythritol, ribulose, tagatose, lactitol, cellobiose, and mixtures thereof.

71. A hydrocolloid prepared by a process comprising:
a) providing a hydrocolloid; and
b) agglomerating said hydrocolloid with a solution comprising a second hydrocolloid and/or a carbohydrate.

72. The method of claim 70 or 71, wherein said hydrocolloid is selected from xanthan gum, guar gum, locust bean gum, gelatin, carrageenan, polygeenan, alginate, pectin, psyllium husk fiber, agar, beta glucan, gellan gum, konjac, carob bean gum, gum Arabic, ghatti gum, karaya gum, tara gum, tragacanth gum, gellan, methyl cellulose, hydroxypropylmethyl cellulose, chitosan, chitin, propylene glycol alginate, and mixtures thereof.

73. The method of claim 72, wherein said hydrocolloid is selected from alginate, pectin, and psyllium husk fiber.

74. The composition of claim 71, wherein said carbohydrate is selected from arabinose, ribose, xylose, xylitol, fructose, galactose, glucose, mannose, sorbitol, sucrose, trehalose, isomalt, lactose, maltose, maltitol, mannitol, erythritol, ribulose, tagatose, lactitol, cellobiose, polydextrose, inulin, corn dextrin, wheat dextrin, and mixtures thereof.

75. The composition of claim 74, wherein said carbohydrate is selected from isomalt, inulin, polydextrose, sucrose, and trehalose.

76. The composition of claim 70 or 71, wherein said second hydrocolloid is selected from xanthan gum, guar gum, locust bean gum, gelatin, carrageenan, polygeenan, alginate, pectin, psyllium husk fiber, agar, beta glucan, gellan gum, konjac, carob bean gum, gum Arabic, ghatti gum, karaya gum, tara gum, tragacanth gum, gellan, methyl cellulose, hydroxypropylmethyl cellulose, chitosan, chitin, propylene glycol alginate, and mixtures thereof.

77. The composition of claim 76, wherein said second hydrocolloid is selected from xanthan and pectin.
